(19) United States
(12) Patent Application Publication
(10) Pub. No.: US 2025/0280312 A1
(43) Pub. Date: Sep. 4, 2025

(54) SYSTEM AND METHOD FOR DEVICE CONFIGURATIONS, NETWORK SERVICE DIAGNOSTICS, AND TICKETING FOR TELECOMMUNICATION DEVICES

(71) Applicant: OCTOLYTICS, INC., Zephyr Cove, NV (US)

(72) Inventors: JESUS MANUEL RODRIGUEZ, Miami Beach, FL (US); JUAN CLAUDIO PAGÉS, Caracas (VE); DANIEL IRIBARREN, Caracas (VE)

(21) Appl. No.: 18/958,487

(22) Filed: Nov. 25, 2024

Related U.S. Application Data
(60) Provisional application No. 63/559,338, filed on Feb. 29, 2024.

(51) Int. Cl. H04W 24/08; H04L 41/16; H04W 8/22

(52) U.S. Cl. CPC H04W 24/08; H04L 41/16; H04W 8/22

(57) ABSTRACT

In one embodiment, a server receives a number of first device configuration parameters of a terminal that are retrievable without providing carrier operator access privileges. The server receives a number of second device configuration parameters of the terminal that are retrievable only with carrier operator access privileges. The server receives signal information and network usage information of the terminal. The server determines one or more historical snapshots of first and second device configuration parameters, signal information, and network usage information for the terminal. The server performs diagnostics for the terminal based on the first and second device configuration parameters, signal information, network usage information, and the one or more historical snapshots to identify malfunctions at the terminal.

### TECHNICAL FIELD

Embodiments of the present disclosure relate generally to cellular service diagnostics. More particularly, embodiments of the disclosure relate to device configurations, network service diagnostics, and ticketing for telecommunication devices.

### BACKGROUND

Radio frequency (RF) drive test measures and assesses the coverage, capacity and Quality of Service (QOS) of a mobile radio network. The drive test technique needs a driver to a motor vehicle in a geographic area to detect and record the signals of mobile network services for the geographic area.

By measuring the wireless network signals of the mobile network services, the RF drive test experiences what a wireless network subscriber would experience in the specific area. Wireless carriers can change their network configurations according to the measured signals to provide better coverage and services to their customers.

Mobile device manufacturers often specify a subset of device configurations that are configurable by the user, there is a challenge for the user to configure their device for a particular mobile network.

### BRIEF DESCRIPTION OF THE DRAWINGS

Embodiments of the disclosure are illustrated by way of example and not limitation in the figures of the accompanying drawings in which like references indicate similar elements.

FIG. 1A is a block diagram illustrating a networked system according to one embodiment.

FIG. 1B is a block diagram illustrating a networked system according to one embodiment.

FIG. 2 is a block diagram illustrating an example of a frontend application according to one embodiment.

FIG. 3 is a user interface of a frontend application according to one embodiment.

FIG. 4 is a user interface indicating operator privilege being granted according to one embodiment.

FIG. 5A-5B illustrate a user interface of configurations according to one embodiment.

FIG. 6 is a block diagram illustrating device registration and validation with and without privileges according to one embodiment.

FIG. 7 is a block diagram illustrating device settings with and without privileges according to one embodiment.

FIG. 8 is a block diagram illustrating device functionalities with and without privileges according to one embodiment.

FIG. 9A-9B illustrate configurations settings for a frontend application according to one embodiment.

FIG. 10 illustrates mobile network signal information according to one embodiment.

FIG. 11A-11B illustrate data usage according to one embodiment.

FIG. 12 illustrates call usage according to one embodiment.

FIG. 13 illustrates SMS usage according to one embodiment.

FIG. 14 is a block diagram illustrating a data collector according to one embodiment.

FIG. 15 is a flow diagram illustrating an example of a method to perform diagnostics according to one embodiment.

FIG. 16 is a block diagram illustrating a monitor module according to one embodiment.

FIG. 17 is a flow diagram illustrating an example of a method to monitor terminal information according to one embodiment.

FIG. 18 illustrates a UI for user to select a base station to service a terminal according to one embodiment.

FIG. 19 is a block diagram illustrating an access network switch module according to one embodiment.

FIG. 20 is a flow diagram illustrating an example of a method to switch an access network device of a terminal according to one embodiment.

FIG. 21 illustrates a UI for a user to create a support ticket according to one embodiment.

FIG. 22 illustrates a UI with historical support tickets according to one embodiment.

FIG. 23 is a block diagram illustrating a ticketing module for a terminal according to one embodiment.

FIG. 24 is a flow diagram illustrating an example of a method to generate a support ticket for a terminal according to one embodiment.

FIG. 25 is a block diagram illustrating a user interface for a server according to one embodiment.

FIG. 26 illustrates a UI with a list of terminals according to one embodiment.

FIG. 27 illustrates a UI with device information for a terminal according to one embodiment.

FIG. 28 illustrates a UI with historical snapshots of diagnostics information for a terminal according to one embodiment.

FIG. 29 illustrates a UI with configuration logs for a terminal according to one embodiment.

FIG. 30 illustrates a UI for a configurations overview of enrolled terminals according to one embodiment.

### DETAILED DESCRIPTION

Various embodiments and aspects of the disclosure will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

RF drive test, although effective, is resource intensive and time consuming for a RF drive test personnel. Obtaining user privilege access for an operator or remote server to configure the device configurations for user devices (e.g., terminal) addresses the user configurability constraints.

Aspects of some embodiments of the present disclosure continually collect and validate the wireless network signals from the cellular service subscribers (e.g., terminal devices). The device configuration parameters of the terminal devices are also collected to rule out device specific performance issues. Further, device configuration parameters of the terminal devices can be checked against predefined configurations to proactively identifying and resolving suboptimal settings for these terminal devices. Through the collection of the wireless network signals from subscriber terminal devices, coverage, capacity and Quality of Service (QOS) of mobile radio networks can be assessed without the costly RF drive tests.

According to a first aspect, a server receives a number of first device configuration parameters of a terminal that are retrievable without providing carrier operator access privileges. The server receives a number of second device configuration parameters of the terminal that are retrievable only with carrier operator access privileges. The server receives signal information and network usage information of the terminal. The server determines one or more historical snapshots of first and second device configuration parameters, signal information, and network usage information for the terminal. The server performs diagnostics for the terminal based on the first and second device configuration parameters, signal information, network usage information, and the one or more historical snapshots to identify malfunctions at the terminal.

In one embodiment, performing diagnostics for the terminal includes comparing the historical snapshots of the first and second device configuration parameters, signal information, and network usage information against the received first and second device configuration parameters, signal information, and network usage information to identify respective differences; and providing an alert when any of the identified differences satisfies a respective predetermined condition.

In one embodiment, performing diagnostics for the terminal includes performing an inference using a machine learning model based on the first and second device configuration parameters, signal information, network usage information, and the one or more historical snapshots; and providing an alert based on a result of the inference.

In one embodiment, the machine learning model is trained to identify one or more configurations that are at fault for degrading a performance of the terminal.

In one embodiment, the network usage information includes: data service data, SMS service data, and voice service data.

In one embodiment, the second device configuration parameters that are retrievable only with carrier operator access privileges include: International Mobile Equipment Identity (IMEI), voice over LTE (VOLTE), access point name (APN) Internet, APN IP Multimedia Subsystem (IMS), Preferred Network Type, Configuration parameters of the Preferred Network Type, and Network selection mode.

In one embodiment, the first device configuration parameters that are retrievable without providing carrier operator access privileges include: brand, model, OS version, manufacturer of the terminal, WiFi configuration, battery saving mode, tethering hotspot configuration, data roaming configuration, and device location.

In one embodiment, the server further reconfigures one least one of the second device configuration parameters at the terminal to diagnose identified malfunctions at the terminal.

In one embodiment, the server further transmits the received first and second device configuration parameters, signal information, and network usage information of the terminal to a carrier operator for the carrier operator to identify terminal malfunctions.

In one embodiment, the server further schedules the first and second device configuration parameters, signal information, and network usage information to be received at a predetermined period from the terminal.

According to second aspect, a terminal determines carrier operator access privileges for an application of the terminal. The terminal determines a number of first device configuration parameters of the terminal that are retrievable without providing carrier operator access privileges. The terminal determines a number of second device configuration parameters of the terminal that are retrievable only with carrier operator access privileges. The terminal determines signal information and network usage information of the terminal. The terminal sends the first and second device configuration parameters, signal information, and network usage information to a server.

In one embodiment, the terminal sends diagnostics information for the terminal to the server, where the server performs diagnostics for the terminal based on the first and second device configuration parameters, signal information, and network usage information, and one or more historical snapshots for the terminal, where the historical snapshots comprise first and second device configuration parameters, signal information, and network usage information for the terminal.

In one embodiment, the diagnostics information is obtained from an inference using a machine learning model based on the first and second device configuration parameters, signal information, network usage information, and the one or more historical snapshots.

In one embodiment, the machine learning model is trained to identify one or more configurations that are at fault for degrading a performance.

In one embodiment, the network usage information comprises: data service data, SMS service data, and voice service data.

In one embodiment, the second device configuration parameters that are retrievable only with carrier operator access privileges comprise: International Mobile Equipment Identity (IMEI), voice over LTE (VOLTE), access point name (APN) Internet, APN IP Multimedia Subsystem (IMS), Preferred Network Type, Configuration parameters of the Preferred Network Type, and Network selection mode.

In one embodiment, the first device configuration parameters that are retrievable without providing carrier operator access privileges comprises: brand, model, OS version, manufacturer of the terminal, WiFi configuration, battery saving mode, tethering hotspot configuration, data roaming configuration, and device location.

In one embodiment, the terminal further receives a reconfiguration request to reconfigure one least one of the second device configuration parameters at the terminal to fix any identified malfunctions at the terminal.

In one embodiment, the terminal further receives a scheduling request from the server, wherein the first and second device configuration parameters, signal information, and network usage information are determined in response to receiving the scheduling request.

According to a third aspect, a terminal determines a number of access network devices that are compatible with a terminal. The terminal receives signal information associated to the access network devices. A user interface of the terminal displays the access network devices and the signal information associated to the plurality of access network devices. In response to a user selection of a target access network device from the access network devices, the terminal circumvents one or more switching policies at a subscriber identity module (SIM) of the terminal. The terminal forces a switch from a current access network device to the target access network device to provide network access services to the terminal or refrains from switching to the target access network device when the terminal receives an instruction from a server not to switch an access network device.

In one embodiment, the signal information includes a transmit signal strength, a receive signal strength, a signal protocol, and/or a carrier operator of the access network device.

In one embodiment, the terminal further sends diagnostics information of the terminal to a server prior to switching the terminal to the target access network device, wherein the diagnostics information includes at least a cellular signal not meeting a threshold or inability of the terminal to transmit cellular data to a carrier operator.

In one embodiment, the terminal reverts the target access network device to a previous access network device to provide network access services to the terminal when the switching is detected to cause a connectivity issue or performance degradation for the terminal.

In one embodiment, the terminal sends a plurality of second device configuration parameters to a server, wherein the second device configuration parameters are retrievable only with carrier operator access privileges and comprise: International Mobile Equipment Identity (IMEI), voice over LTE (VOLTE), access point name (APN) Internet, APN IP Multimedia Subsystem (IMS), Preferred Network Type, Configuration parameters of the Preferred Network Type, and Network selection mode.

In one embodiment, the terminal sends a plurality of first device configuration parameters to a server, wherein the first device configuration parameters are retrievable without providing carrier operator access privileges and comprise: brand, model, OS version, manufacturer of the terminal, WiFi configuration, battery saving mode, tethering hotspot configuration, data roaming configuration, and device location.

In one embodiment, the terminal receives an indication from a server that indicates whether malfunctions have been identified at the terminal based on a diagnostics of the terminal using the first and second device configuration parameters of the terminal; in response to receiving an access network device change request from a Mobile Virtual Network Operator (MVNO) or a Mobile Network Operator (MNO), the terminal overrides the request when there is a user selection for a target access network device; the terminal performs the access network device change request when there is an absence of a user selection for a target access network device or when there is an indication of identified malfunctions at the terminal.

According to a fourth aspect, a system determines diagnostics information for a terminal. The system generates a support ticket for the terminal based on the diagnostics information of the terminal, the support ticket corresponding to one of a plurality of carrier operators. The system attaches the diagnostics information to the support ticket such that the support ticket includes diagnostics information for the terminal at a time when the support ticket is opened. The system sends the support ticket to the carrier operator.

In one embodiment, the diagnostics information includes a plurality of first device configuration parameters of the terminal that are retrievable without providing carrier operator access privileges, a plurality of second device configuration parameters of the terminal that are retrievable only with carrier operator access privileges, and signal information and network usage information of the terminal.

In one embodiment, the network usage information comprises: data service data, SMS service data, and voice service data.

In one embodiment, the second device configuration parameters that are retrievable only with carrier operator access privileges comprise: International Mobile Equipment Identity (IMEI), voice over LTE (VOLTE), access point name (APN) Internet, APN IP Multimedia Subsystem (IMS), Preferred Network Type, Configuration parameters of the Preferred Network Type, and Network selection mode.

In one embodiment, the first device configuration parameters that are retrievable without providing carrier operator access privileges comprise: brand, model, OS version, manufacturer of the terminal, WiFi configuration, battery saving mode, tethering hotspot configuration, data roaming configuration, and device location.

In one embodiment, generating a support ticket for the terminal includes generating in an application of the terminal, the support ticket for the terminal; or generating, by a server, the support ticket for the terminal.

In one embodiment, the support ticket is used by the carrier operator to track and diagnose a mobile connectivity issue at the terminal and the support ticket is closed when then mobile connectivity issue at the terminal is resolved.

According to a fifth aspect, a display system includes a display interface and a memory storing instructions. When the instructions are executed by one or more processors, the system is configured to display in the display interface: a number of terminals with associated terminal device information, APN information, VOLTE information, and current device configuration parameters. For each terminal, the system displays a number of configuration logs of the terminal, each configuration log indicating a time of change of configuration settings of the terminal, a previous configuration setting, and a current configuration setting of the terminal. The system displays a number of historical snapshots of diagnostics information reported by the terminal, each of the historical snapshots including customer experience information reported by the terminal, a location information reported by the terminal, and a time of capture of the historical snapshot. Using the customer experience information and location information, geographical area coverage, data capacity and Quality of Service (QOS) of wireless networks can be assessed.

In one embodiment, the compliance information reported by the terminal includes a plurality of first device configuration parameters of the terminal that are retrievable without providing carrier operator access privileges; a plurality of second device configuration parameters of the terminal that are retrievable only with carrier operator access privileges; and signal information and network usage information of the terminal.

In one embodiment, the network usage information comprises: data service data, SMS service data, and voice service data.

In one embodiment, the second device configuration parameters that are retrievable only with carrier operator access privileges includes International Mobile Equipment Identity (IMEI), voice over LTE (VOLTE), access point name (APN) Internet, APN IP Multimedia Subsystem (IMS), Preferred Network Type, Configuration parameters of the Preferred Network Type, and Network selection mode.

In one embodiment, the first device configuration parameters that are retrievable without providing carrier operator access privileges includes brand, model, OS version, manufacturer of the terminal, WiFi configuration, battery saving mode, tethering hotspot configuration, data roaming configuration, and device location.

In one embodiment, the configuration log of the terminal indicates a time of change of configuration settings of the terminal, a previous configuration setting, and a current configuration setting of the terminal.

In one embodiment, the first and second device configuration parameters, and mobile service parameters are updatable at a predetermined period.

In one embodiment, the display interface further displays a customer sentiment indicator for each of the plurality of terminals.

The embodiments of this application may be applied to a plurality of communications systems. The systems to which the embodiments of this application are applicable to an LTE system, an LTE Advanced system, a 5^{th} generation (5G) communications system, or the like. These system can include a global system for mobile communications (GSM), a code division multiple access (CDMA) system, wideband code division multiple access (WCDMA) system, a general packet radio service (GPRS) system, a universal mobile telecommunications system (UMTS), and the like. This is not limited in the embodiments of this application.

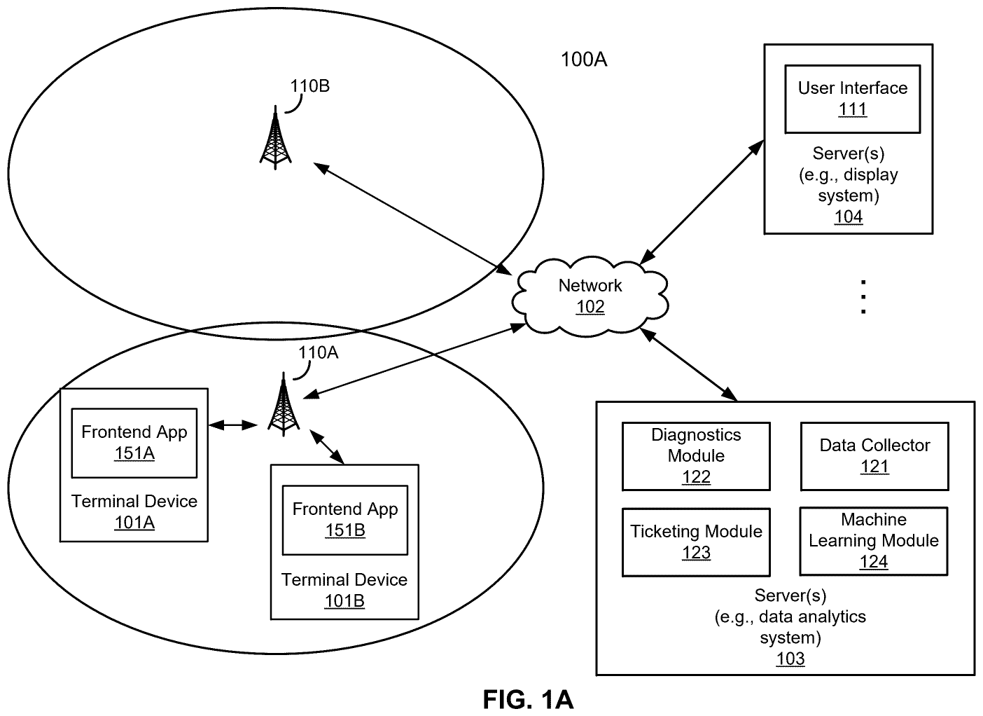

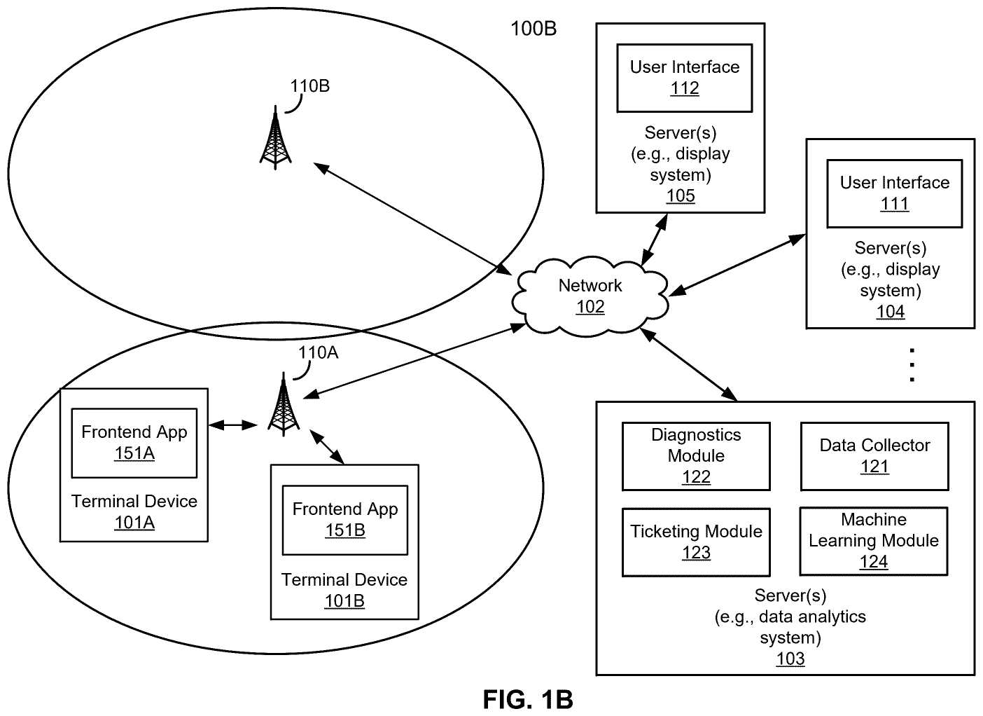

FIGS. 1A-1B are schematic diagrams of a network 102 to which embodiments of this application are applicable. Network 102 shown in FIGS. 1A-1B may include network device 110A-110B and terminal device 101A-101B. Network device 110A-110B can belong to a single or multiple mobile network operators (MNOs). For example, network device 110A can belong to mobile network operator 1 and network device 110B can belong to a mobile network operator 2. The mobile network operators 1-2 can provide services to one or more mobile virtual network operators (MVNOs). In one embodiment, some or all of terminal device 101A-101B can be serviced by one or more MNOs and/or MVNOs. In one embodiment, the cell coverage of network device 110A can be the same, overlapping or non-overlapping compared to the cell coverage of network device 110B. It should be noted that each of the network(s) of FIGS. 1A-1B can include at least one network device, and there can be at least one terminal device that communicates with each network device. This is not limited to the number of network devices shown in FIGS. 1A-1B and the number of terminal devices shown in FIGS. 1A-1B.

Terminal device 101A-101B in the embodiments of this application can provide a user with short messaging service (SMS), voice, and/or data connectivity. Terminal device 101A-101B can be a handheld device with a wireless connection function, or another processing device connected to a wireless modem. The wireless terminal device may communicate with one or more core networks through a random access network (RAN) (not shown). The wireless terminal device may be a mobile terminal device, such as a mobile phone (also referred to as a “cellular” phone) and a computer with a mobile terminal device, for example, may be a portable, pocket-sized, handheld, computer built-in, or in-vehicle mobile apparatus, which exchanges SMS, voice, and/or data with the RAN. For example, it may be a device such as a personal communication service (PCS) phone, a cordless telephone set, a session initiation protocol (SIP) phone, a wireless local loop (WLL) station, or a personal digital assistant (PDA). The wireless terminal device may also be referred to as a system, a subscriber unit, a subscriber station, a mobile station, a remote station, an access point (AP), a remote terminal device, an access terminal device, a user terminal device, a user agent, a user device, or user equipment, etc.

In one embodiment, terminal device 101A-101B can include frontend application 151A-151B. Frontend application 151A-151B can include user interfaces to display measurements for wireless network signal of the terminal device. Frontend application 151A-151B can further communicate with a server, such as server(s) 103-104 of FIGS. 1A-1B.

Referring to FIG. 1A, network device 110A-110B can be a cell, a base station, an access point, or a device in an access network. Network device 110A-110B can communicates with a wireless terminal device on an air interface by using one or more sectors. For example, the network device may be an evolved NodeB (or e-NodeB) in an LTE system, LTE Advanced system, or may be a base station in a 5G system. Some functions of the network device can include: radio resource management, internet protocol (IP) header compression and user data stream encryption, mobility management entity (MME) selection when a terminal device is attached, routing user plane data to a serving gateway (S-GW), organization and sending of paging messages, organization and sending of broadcast messages, measurement and measurement report configuration for mobility or scheduling purposes, and the like.

Referring to FIGS. 1A-1B, terminal device 101A-101B of systems 100A-100B can be communicatively coupled to server(s) 103-104 over network 102. Network 102 may include different types of networks such as a mobile cellular network, local area network (LAN), a wide area network (WAN), Internet, a fiber network, a storage network, or a combination thereof, wired or wireless. Terminal device 101A-101B may be in physical proximity or may be physically remote from one another. Servers 103-104 may be located in proximity to one, both, or neither of terminal device 101A-101B.

Server 103 may be a data analytics system that performs data analytics services for a number of terminal devices. In one embodiment, server 103 includes data collector 121, diagnostics module 122, ticketing module 123, and machine learning module 124. Data collector 121 can monitor key performance indicators (KPIs) of terminal devices. The monitored KPIs can measure the connectivity/cellular performances of the terminal devices. Diagnostics module 122 can diagnose a particular terminal device to resolve any connectivity/performance issues. Ticketing module 123 can create a support ticket with a respective MNO or MVNO on behalf of a user of a terminal device. Based on the support tickets, the MNO or MVNO can track and resolve performance and/or cellular connectivity issues for the terminal devices. Machine learning module 124 can provide machine learning (ML) models/algorithms to diagnose the terminal device for connectivity/performance issues. Some examples of ML models/algorithms include transformers, deep neural networks (DNN), long short term memory (LSTMs) for the time-based snapshots for the terminal, reinforcement models, support vector machine (SVM), k-nearest neighbor (kNN), regression, random forest, decision tree, naïve bayes, k-means, etc. Note that modules 121-124 may be integrated as an integrated module.

Server 104 may be a display system to display the monitored data for the terminal devices. The display system can provide visual cues for the support staff to assess coverage, capacity, and QoS for wireless mobile networks. The display system can further provide diagnostics for homologation, performance, and/or cellular connectivity issues for the terminal devices. In one embodiment, server 104 includes user interface 111. User interface can include different display modules to show different aspects of the monitored data as further described below. Note that homologation describes compatibility of a terminal device and anticipates how a device behave in response to network operator services. Homologation can include SDK homologation and operator homologation. SDK homologation refers to compatibility of a terminal device 101A against the SDK of frontend application 151A. Operator homologation refers to compatibility of the terminal device against operator services (e.g., voice, SMS and data services). When homologation compatibility is 100%, a terminal device is typically categorized to work with plug-and-play and no additional configuration is needed.

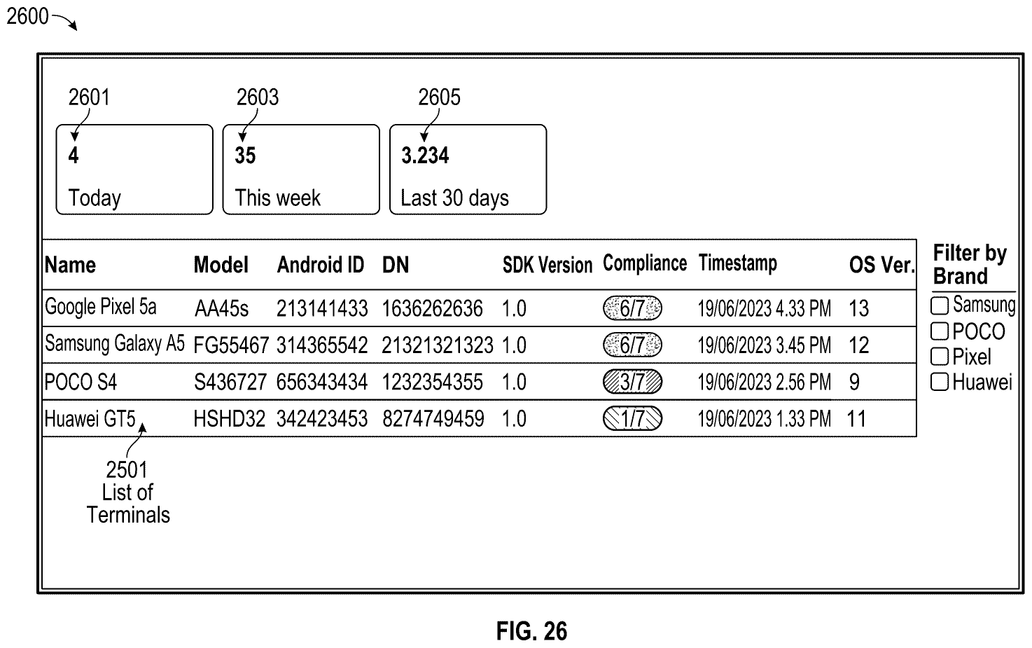

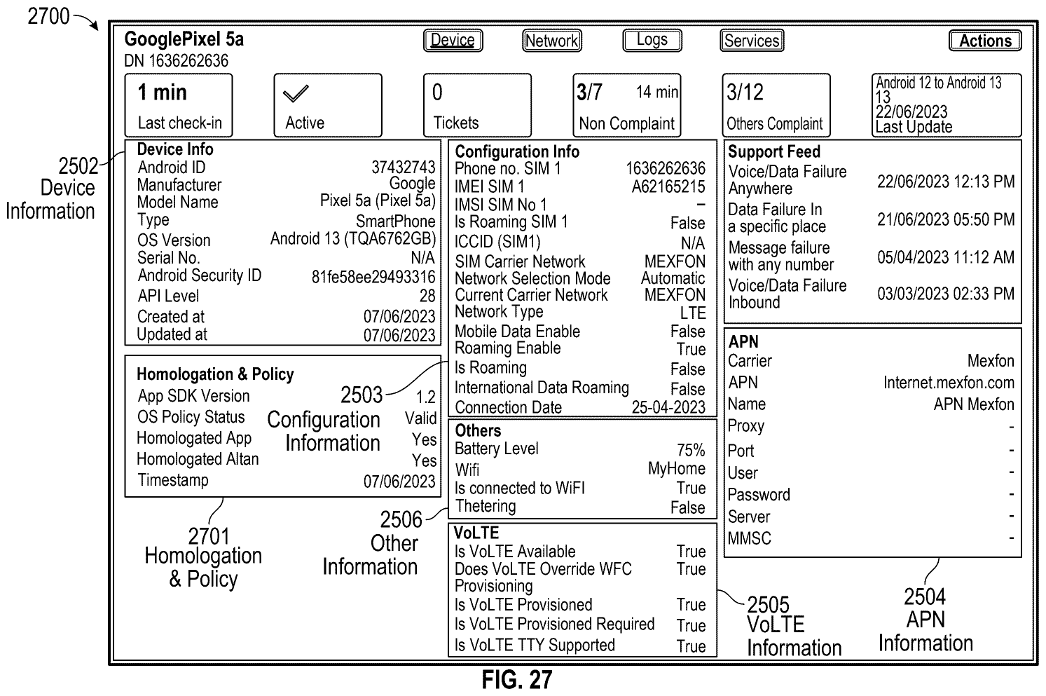

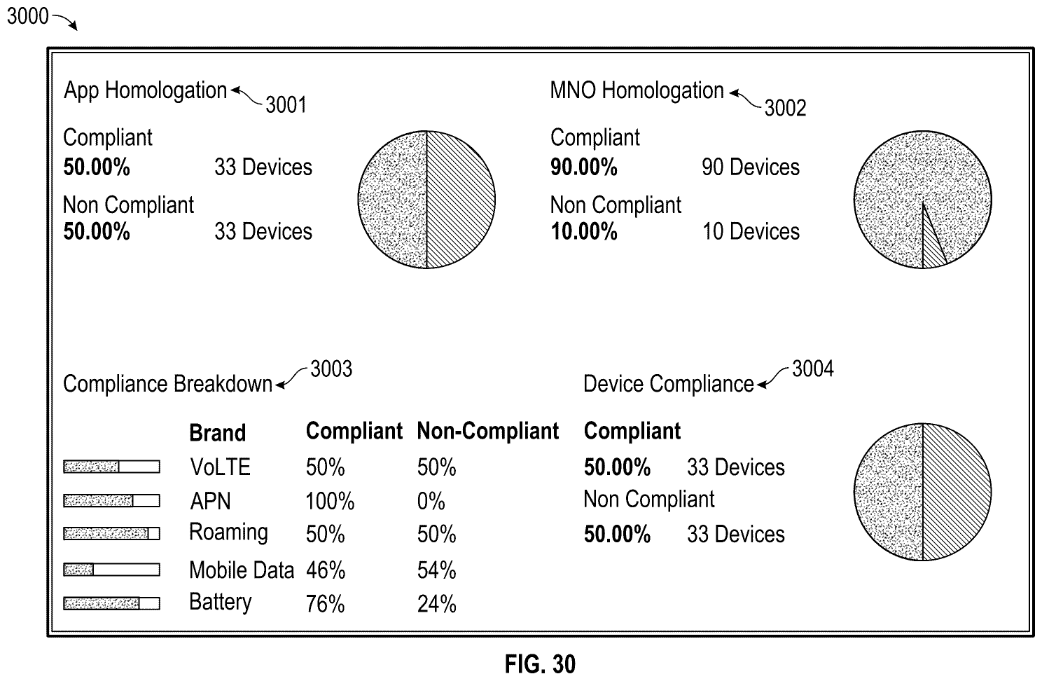

Referring to FIG. 1B, in one embodiment, UI 112 of server 105 can show an overview of homologation, performance, and/or cellular connectivity reported by all terminal devices 101A-101B (e.g., FIGS. 26 and 30), while UI 111 of server 104 can show homologation, performance, and/or cellular connectivity reported by a particular terminal device (e.g., FIGS. 27-29), such as terminal device 101A. In one embodiment, when a terminal device reports performance, and/or cellular connectivity issues, UI 111 of server 104 can automatically display the homologation, performance, and/or cellular connectivity for the terminal device. In one embodiment, when a terminal device is diagnosed with performance, and/or cellular connectivity issues, UI 111 of server 104 can automatically display the homologation, performance, and/or cellular connectivity for the terminal device.

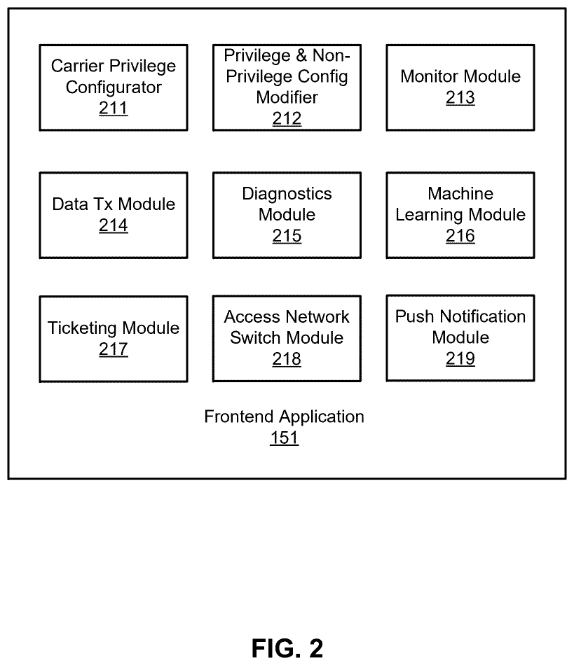

FIG. 2 is a block diagram illustrating an example of a frontend application 151 for a terminal device according to one embodiment. Frontend application 151 can be hosted at generic application distribution channels, such as Google Play, etc. Frontend application 151 can retain special privileges on devices without the need to sign applications with the platform certificate per device or pre-install as a system app. For example, Android 5.1 introduced a mechanism to grant special privileges for APIs relevant to owners of Universal Integrated Circuit Card (UICC) applications. The Android platform can load certificates stored on a UICC (e.g., SIM card) and grant permission to applications signed by these certificates to make calls to a set of APIs. These API calls can provide operator access configuration settings and device parameters that would not be otherwise available. In one embodiment, frontend application has special privileges (provided that a user of the terminal device granted the permission) to make calls to these APIs to obtain configuration settings, network usage data, and device parameters of the terminal device.

In one embodiment, frontend application 151 includes carrier privilege configurator 211, privilege and non-privilege configuration modifier 212, monitor module 213, data transmission module 214, diagnostics module 215, machine learning module 216, ticketing module 217, access network switch module 218, and push notification module 219. Carrier privilege configurator 211 can configure the frontend application with special privileges to access APIs. In one embodiment, frontend application is a carrier application. Privilege and non-privilege configuration modifier 212 can configure configuration parameters for a terminal device. These configuration parameters can include settings that can be configured with or without access privileges. Examples of configuration parameters that are configurable with operator privileges include roaming/nonroaming networks, Visual voicemail, SMS/MMS network settings, and VOLTE/IMS configurations.

Note that Voice over LTE (VOLTE) is an LTE high-speed wireless communication standard for voice calls for terminals. VOLTE can have up to three times more voice and data capacity than 3G. VOLTE uses less bandwidth because packet headers of VOLTE are smaller than those of VOIP/LTE. IP Multimedia Subsystem or IP Multimedia Core Network Subsystem (IMS) is a standardized architectural framework for delivering IP multimedia services, such as voice over IP (VOIP). Various VOIP technologies are available on smartphones and IMS can provide a standard protocol across different vendors.

Examples of configuration parameters configurable without a grant of operator privileges include WIFI configuration, battery saving mode, tethering configuration, and device location. In one embodiment, frontend application can be queried by a remote server to configure these terminal settings. Monitor module 213 can monitor configuration changes, KPIs of the terminal device and stored these data as snapshots locally or remotely. Data transmission (Tx) module 214 can push the monitored data to a remote server, such as analytics server 103 of FIGS. 1A-1B. Diagnostics module 215 can perform diagnostics to the terminal device. Machine learning module 216 can perform inference on a set of monitored data/historical snapshots using a machine learning model. Ticketing module 217 can open a support ticket with a MNO or MVNO on behalf of a user of the terminal device. Access network switch module 218 can switch an access network device of the terminal. Access network device can refer to a base station, access point, eNB, etc. that is directly accessed by the terminal to provide wireless services to the terminal. Push notification module 219 can push a notification to the terminal. For example, server and/or frontend app can signal a short message that appears as a pop-up on a home screen or notification center of a terminal. Push notifications can be opt-in alerts that display text and/or graphics to enable a user to take a specific action. Some or all of modules 211-219 can be an integrated module.

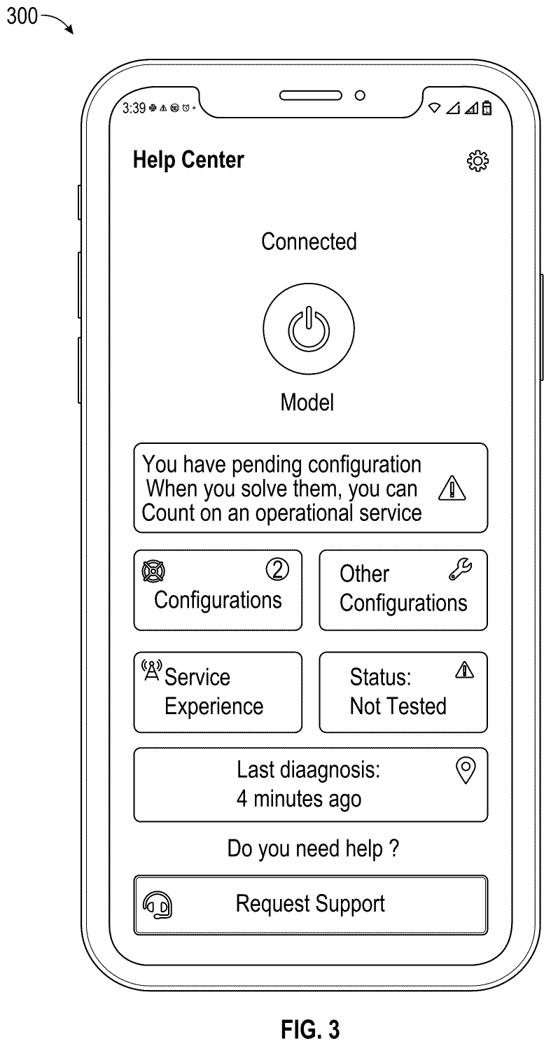

FIG. 3 is a user interface of a frontend application according to one embodiment. User interface (UI) 300 can show a connection status of the frontend application (app) with controls for different functionalities of the app. In one embodiment, app includes a software development kit (SDK) to interact with mobile operators. In one embodiment, UI 300 includes controls to setup configuration parameters that require operator privileges, other configuration parameters that does not need operator privileges, view/edit service experience, view/edit status of diagnosis. These controls can be touch-based clickable buttons or panels. Each of these controls can instantiate a new user interface at the frontend application. In summary, functionality related to diagnosing and validating configuration parameters of a terminal device can exist in two modalities: with operator privilege or without operator privilege. In one embodiment, app requires an end user's permission for the operator privilege to access operator specific functionalities. In one embodiment, once the end user permission is provided, the app can interact with a mobile network and configure operator functionalities related to connectivity (APN, VOLTE, Preferred Network Type, Selection Method, etc.).

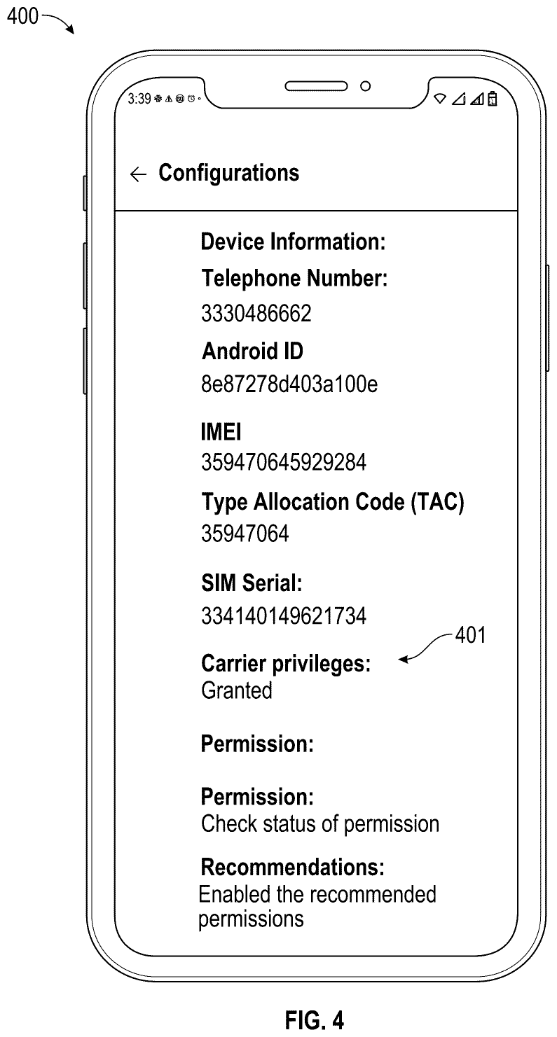

FIG. 4 is a user interface 400 indicating operator privilege being granted according to one embodiment. UI 400 can correspond to the configurations panel of FIG. 3. As shown in UI 400, status of the carrier privileges 401 (or carrier operator access privileges) can indicate a status of granted. With the operator privilege granted, a user of the terminal device can self-manage operator privilege related configurations.

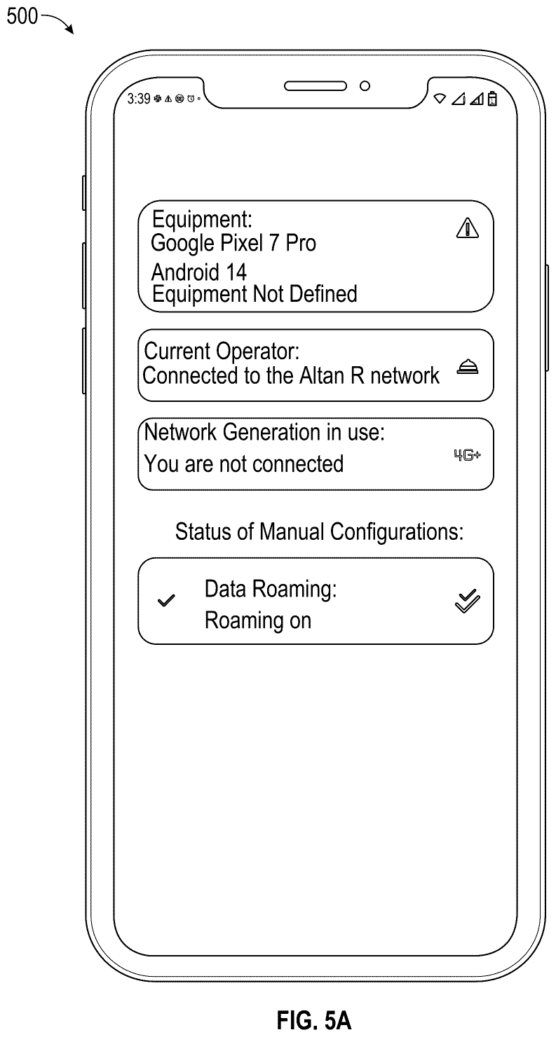

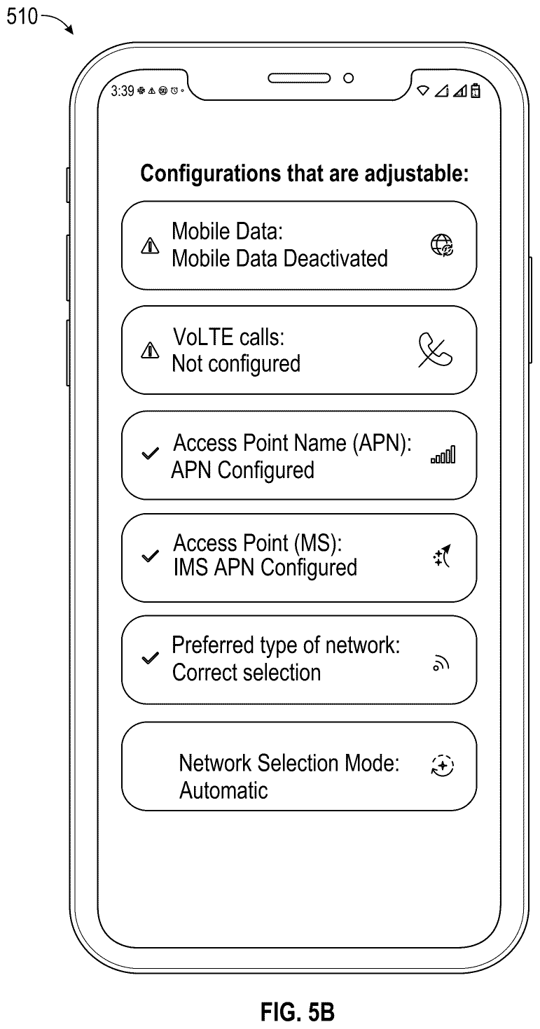

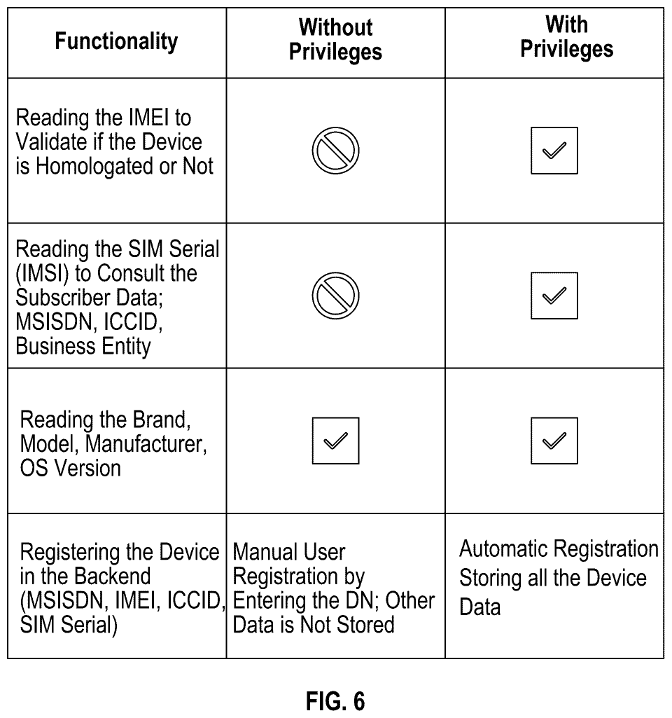

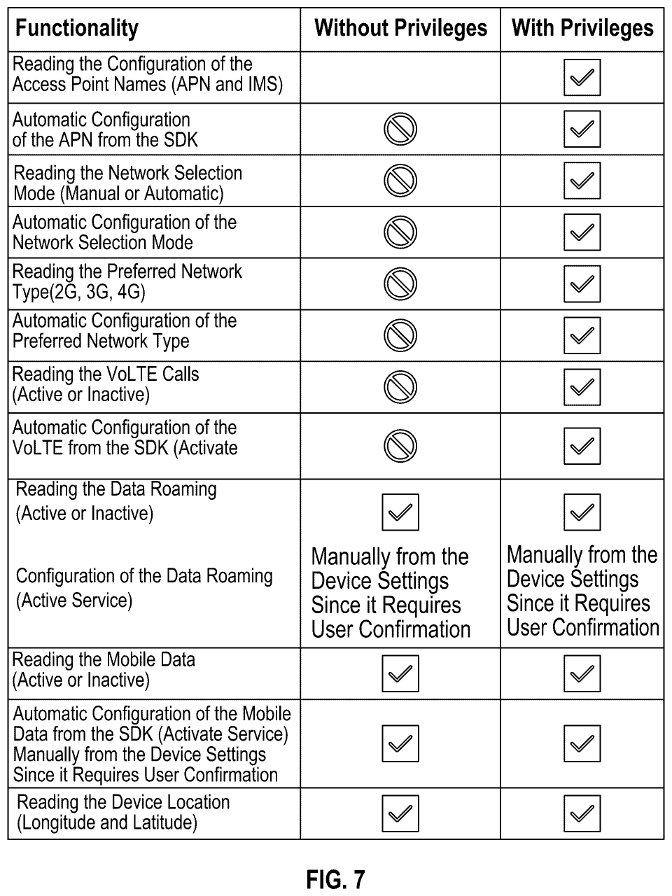

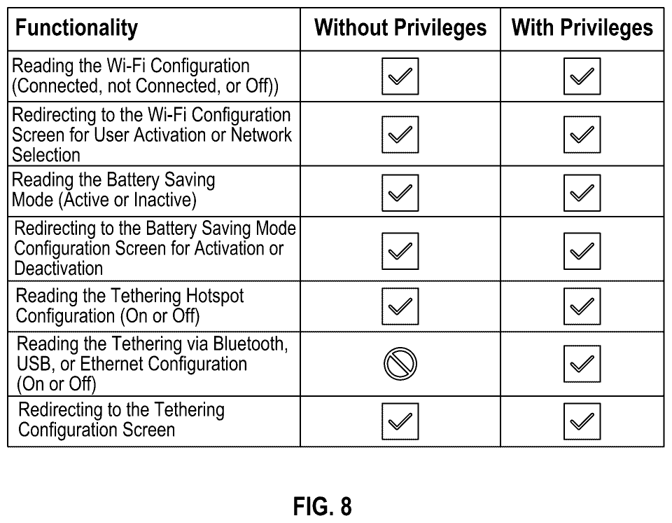

FIG. 5A-5B illustrate a user interface 500-510 of configurations according to one embodiment. UI 500 in FIG. 5A can show configurations that are viewable. UI 510 of FIG. 5B can show configurations that are configurable. In one embodiment, the configurations can be modified by a user or a remote server for the terminal device. FIG. 6-8 illustrate some parameters (APN, IMSI, IMEI, ICCID, etc.) that can be viewed/modified with and without the need of operator privileges. The parameters that require carrier privileges can include APN, VOLTE, Preferred Network Type, Selection Method, etc. The parameters that does not require carrier privileges can include reading/configuring of the WIFI configuration, tether hotspot configuration, battery saving mode, etc. Through adjustments of these configuration parameters, performance/inapt configurations of the terminal device can be improved/fixed.

Note that an Access Point Name (APN) is a name of a gateway between a mobile network (GSM, GPRS, 3G, 4G and 5G) and a computer network, frequently the public Internet. International Mobile Subscriber Identity (IMSI) is a unique identification number assigned to each subscriber in a Global System for Mobile Communications (GSM), Universal Mobile Telecommunications System (UMTS), or other mobile network. It consists of 15 digits and is stored on a SIM card. Mobile Station International Subscriber Directory Number (MSISDN) is the full phone number assigned to a mobile device. It includes the country code, network code, and subscriber number. Integrated Circuit Card Identifier (ICCID) is a unique identification number that is assigned to a SIM card. It is used to identify the SIM card in a mobile network.

Subscriber Identity Module (SIM) is a small card inserted into a mobile device that identifies and authenticates the subscriber on a mobile network. It stores information such as the IMSI, ICCID, and an authentication key, allowing the user to access the network's services. International Mobile Equipment Identity (IMEI) number is a numeric identifier, usually unique for 3GPP mobile phones, as well as some satellite phones. IMEI can be found printed inside some battery compartment of a mobile phone and can also be displayed on-screen in the system configurations of most mobile phones.

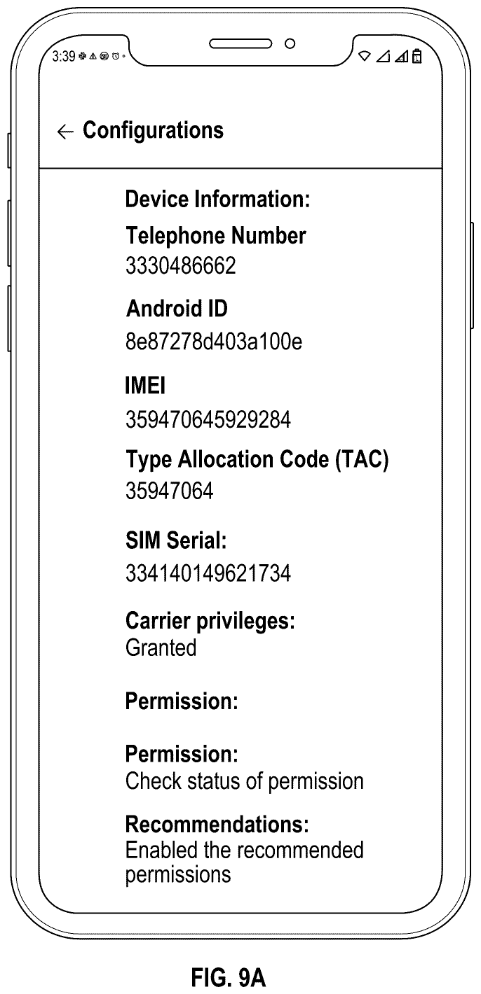

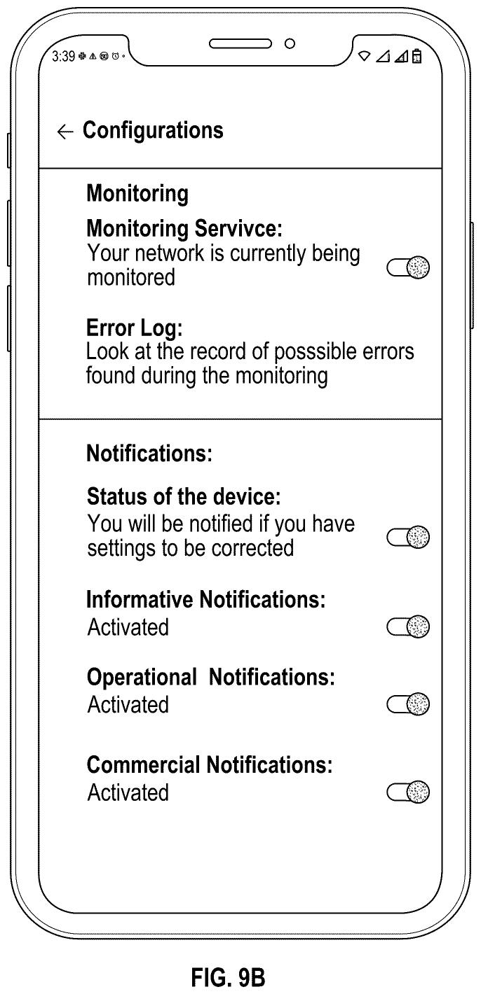

FIG. 9A-9B illustrate configurations settings for an app (such as App 151A-151B of FIG. 1) according to one embodiment. As described above, the app can include a configuration panel that indicates device information such as the telephone number associated to the terminal device, an OS identifier (Android ID), International Mobile Equipment Identity (IMEI), type allocation code (TAC), SIM serial, status of carrier privileges, the user permission granted to the app, status of monitor service, and error log, etc. The configuration settings can include notifications statuses for the device status (whether there are settings to be corrected), such as informational notifications-low priority notifications that are information only, operational notifications-high priority notifications that affects the operation of the terminal device, and commercial notifications-a public warning system.

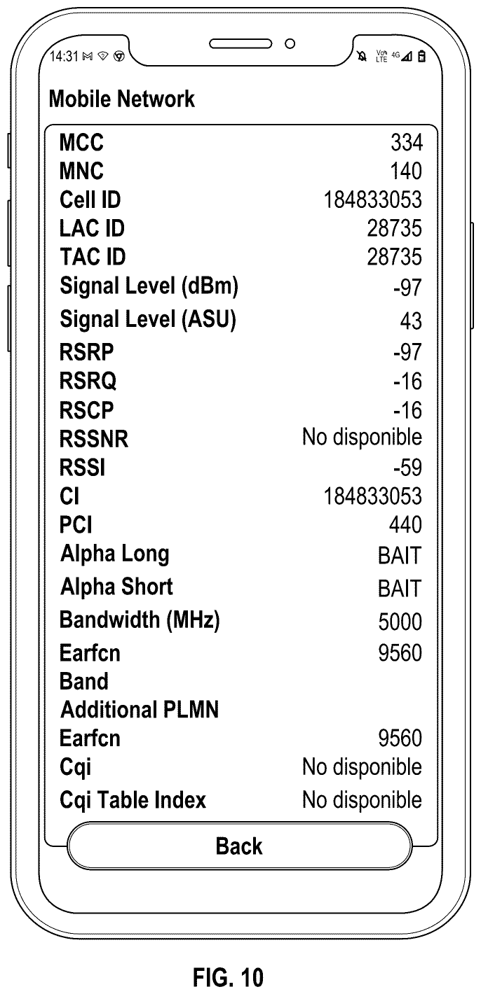

FIG. 10 illustrates mobile network signal information according to one embodiment. The network signal information can correspond to the information of the signal for the terminal device. For example, the signal information can include signal level (dBm), RSRP, RSRQ, RSCP, RSSNR, RSSI, CI, PCI, alpha long, alpha short, EARFCN, etc. Although only a limited number of values are shown in FIG. 10 for purposes of illustration, the signal information can include other values for the signals of a network. Note that E-UTRA Absolute Radio Frequency Channel Number (EARFCN) is a unique identifier for a RF channel in a Long Term Evolution (LTE) cellular network.

Note that Type Allocation Code (TAC) is a unique identifier assigned to mobile devices, such as smartphones and tablets. TAC is the first eight digits of an International Mobile Equipment Identity (IMEI) number. TAC helps identify the manufacturer and model of a device. Mobile Country Code (MCC) is a three-digit code used to identify the country in which a mobile network operator is registered. MCC is a part of the IMSI and is used in combination with the MNC to uniquely identify a mobile network operator within a country. Mobile Network Code (MNC) is a two- or three-digit code used to identify a mobile network operator within a specific country. Cell ID is a unique identifier assigned to each cell in a cellular network. Cell ID is used to distinguish one cell from another and is crucial for devices to determine their location within the network. Location Area Code (LAC) ID is a unique identifier assigned to a group of cells in a cellular network. TAC ID is an identifier for the Type Allocation Code.

Decibels relative to milliwatt (dBm) is a unit of measurement for power levels in a signal. Arbitrary Strength Unit (ASU) is a unit of measurement used to represent signal strength on mobile devices. Reference Signal Received Power (RSRP) is a metric used to measure the power level of reference signals in a cellular network. Reference Signal Received Quality (RSRQ) is a metric used to measure the quality of received reference signals in a cellular network. Received Signal Code Power (RSCP) is a metric used in UMTS networks to measure the received signal strength. Received Signal Strength to Noise Ratio (RSSNR) is a metric used to measure the ratio of the received signal strength to the background noise level in a cellular network. Received Signal Strength Indicator (RSSI) is a metric used to measure the strength of the received signal in a cellular network. Cell Identity (CI) is a unique identifier assigned to each cell in a cellular network. Physical Cell Identity (PCI) is a parameter used in LTE and 5G cellular networks. Public Land Mobile Network (PLMN) refers to a mobile network operator's network infrastructure that provides cellular communication services to the public. Channel Quality Indicator (CQI) is a metric used in LTE and 5G networks to measure the quality of the radio channel between a mobile device and the base station.

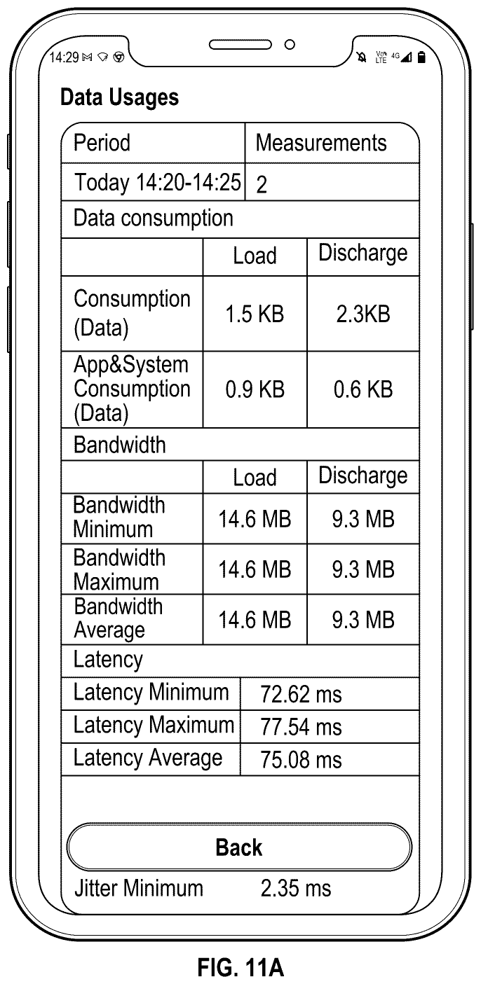

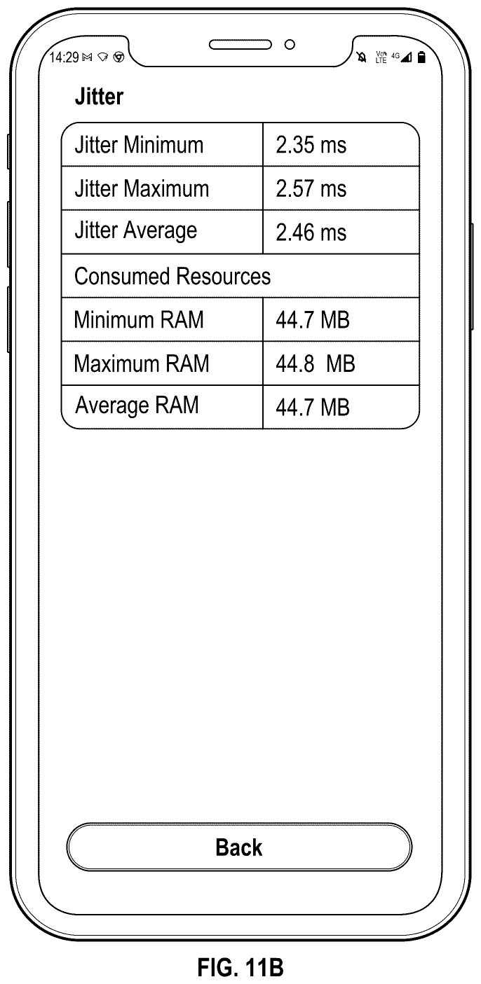

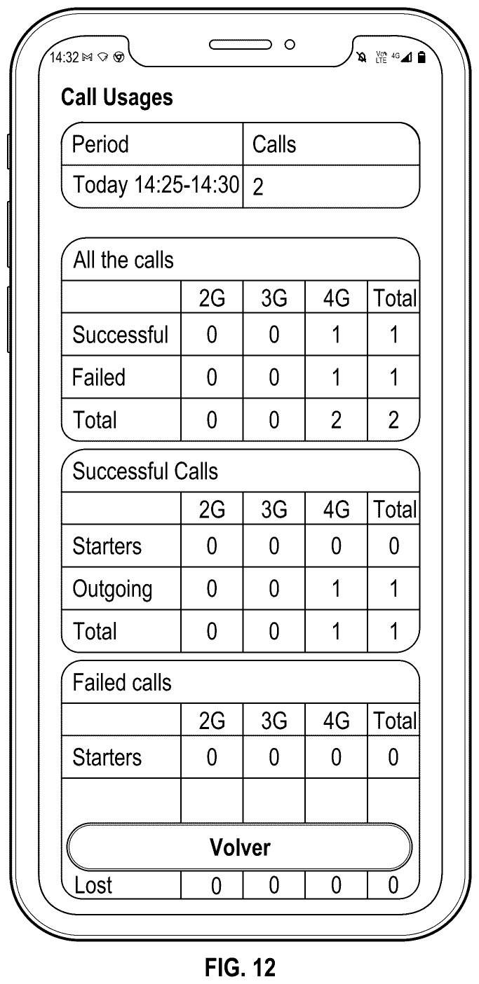

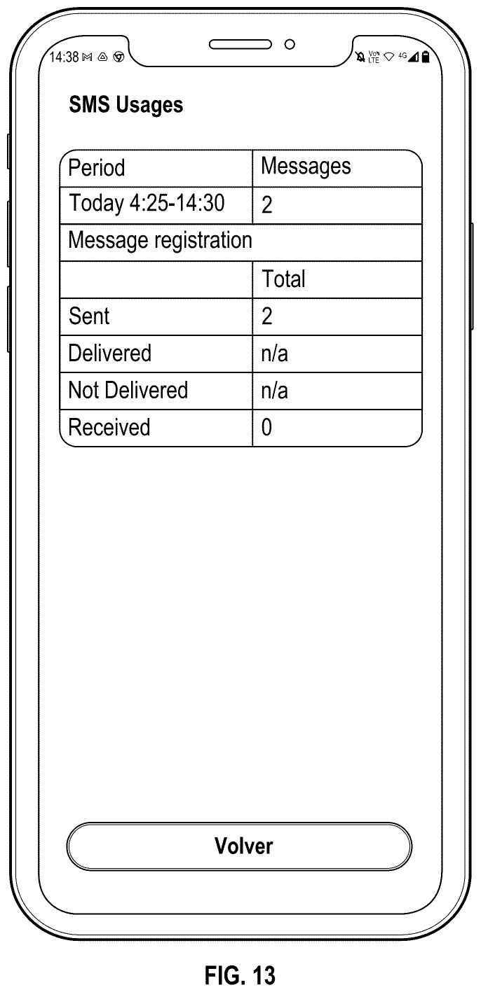

Network usage information of a terminal device can include data, call, and/or SMS usages. FIG. 11A-11B illustrate data usage according to one embodiment. FIG. 12 illustrates call usage according to one embodiment. FIG. 13 illustrates SMS usage according to one embodiment. These usages can be measured for a predetermined period (configurable by server 103), e.g., 5 minute intervals or any other intervals. In some embodiment, these usages can be monitored by frontend app. The monitored usages can be automatically uploaded to a remote server for the remote server to generate historical snapshots of the monitored usages for analytics and diagnoses of the terminal device.

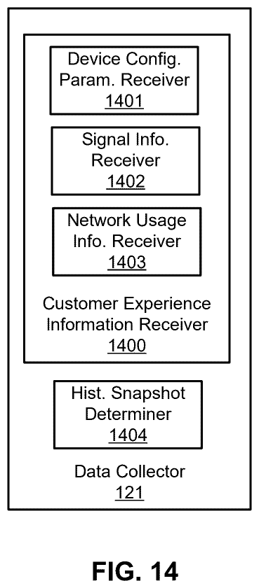

FIG. 14 is a block diagram illustrating a data collector 121 of server 103 according to one embodiment. Data collector 121 can collect data from a terminal device. In one embodiment, data collection 121 includes customer experience information receiver 1400 and historical snapshot determiner 1404. Customer experience information can correspond to device configuration parameter, signal information, and/or network usage information. Customer experience information receiver 1400 can include device configuration parameter receiver 1401, signal information receiver 1402, and network usage information receiver 1403. Device configuration parameter receiver 1401 can receive a plurality of first or second device configuration parameters from a terminal. Signal information receiver 1402 can receive signal information from a terminal. Network usage information receiver 1403 can receive network usage (data, voice, and/or SMS usages) information from a terminal. The customer experience information for a terminal can be received periodically at predetermined intervals. For example, a server, such as server 103, can send a request to the terminal to schedule how frequently (e.g., 5, 10, 60 minutes interval, etc.) the terminal is to send the customer experience information to the server. Historical snapshot determiner 1404 can generate a historical snapshot from a set of first and second device configuration parameters, signal information, and/or network usage information (e.g., customer experience information) for a terminal. A historical snapshot can be associated to a terminal device identifier and a timestamp indicating a time when the snapshot is generated. Some or all of modules 1400-1404 can be integrated into a single module.

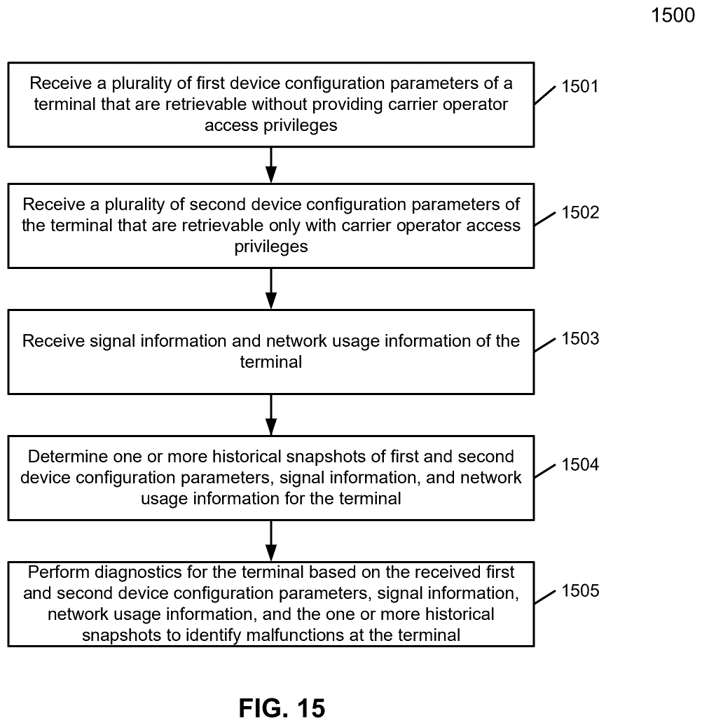

FIG. 15 is a flow diagram illustrating an example of a method to perform diagnostics according to one embodiment. Process 1500 may be performed by processing logic which may include software, hardware, or a combination thereof. For example, process 1500 may be performed by data collector 121 and diagnostics module 122 of FIG. 1.

Referring to FIG. 15, at block 1501, processing logic receives first device configuration parameters of a terminal that are retrievable without providing carrier operator access privileges.

At block 1502, processing logic receives second device configuration parameters of the terminal that are retrievable only with carrier operator access privileges.

At block 1503, processing logic receives signal information and network usage information of the terminal.

At block 1504, processing logic determines one or more historical snapshots of first and second device configuration parameters, signal information, and/or network usage information for the terminal.

At block 1505, processing logic performs diagnostics for the terminal based on the first and second device configuration parameters, signal information, network usage information, and the one or more historical snapshots to identify malfunctions at the terminal.

In one embodiment, performing diagnostics for the terminal includes comparing the historical snapshots of the first and second device configuration parameters, signal information, and network usage information against the obtained first and second device configuration parameters, signal information, and network usage information to identify differences in the configuration parameters, and providing an alert when any of the identified differences satisfies a respective predetermined condition. In one embodiment, the first and second device configuration parameters, signal information, and network usage information are compared with predetermined thresholds to determine whether to provide an alert. The alert can be a warning label besides a configuration parameter indicating possible configuration errors for that configuration parameter, as shown in FIG. 5A-5B.

In one embodiment, performing diagnostics for the terminal includes performing inference using a machine learning model based on the first and second device configuration parameters, signal information, network usage information, and the one or more historical snapshots and providing an alert based on a result of the inference.

In one embodiment, the machine learning model is trained to identify one or more configurations that are at fault for degrading a performance of the terminal.

In one embodiment, the network usage information comprises: data service data, SMS service data, and/or voice service data.

In one embodiment, the second device configuration parameters that are retrievable only with carrier operator access privileges comprise: International Mobile Equipment Identity (IMEI), voice over LTE (VOLTE), access point name (APN) Internet, APN IP Multimedia Subsystem (IMS), Preferred Network Type, Configuration parameters of the Preferred Network Type, and Network selection mode.

In one embodiment, the first device configuration parameters that are retrievable without providing carrier operator access privileges comprise: brand, model, OS version, manufacturer of the terminal, WiFi configuration, battery saving mode, tethering hotspot configuration, data roaming configuration, and device location.

In one embodiment, processing logic further reconfigures one least one of the second device configuration parameters at the terminal to diagnose identified malfunctions at the terminal.

In one embodiment, processing logic further transmits the obtained first and second device configuration parameters, signal information, and network usage information of the terminal to a carrier operator (e.g., MNO or MVNO) for the carrier operator to identify terminal malfunctions.

In one embodiment, processing logic further schedules the first and second device configuration parameters, signal information, and network usage information to be received at a predetermined period from the terminal.

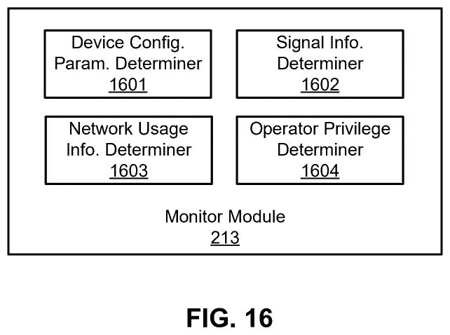

FIG. 16 is a block diagram illustrating a monitor module 213 of a frontend app according to one embodiment. Monitor module 213 can monitor network usage information, signal information, and device configuration parameter changes of a terminal device. In one embodiment, monitor module 213 includes device configuration parameter determiner 1601, signal information determiner 1602, network usage information determiner 1603, and operator privilege determiner 1604. Device configuration parameter determiner 1601 can determine a plurality of first or second device configuration parameters of the terminal. Signal information determiner 1602 can determine signal information of the terminal. Network usage information determiner 1603 can determine network usage (data usage, voice usage, and/or SMS usage) information for the terminal. These customer experience information (e.g., device configuration parameters, signal information and/or network usage information) for the terminal can be determined periodically at predetermined intervals for the terminal/server to check if a compliance requirement for each of these parameters/signals is met. For example, a server, such as server 103, can send a request to the terminal to schedule how frequently (e.g., 5, 10, 60 minutes interval, etc.) the terminal is to send these customer experience information to the server. Operator privilege determiner 1604 can determine if an end user has granted operator privilege to the frontend application. The operator privilege allows the frontend application to access operator privileged information as described above. Some or all of modules 1601-1604 can be integrated into a single module.

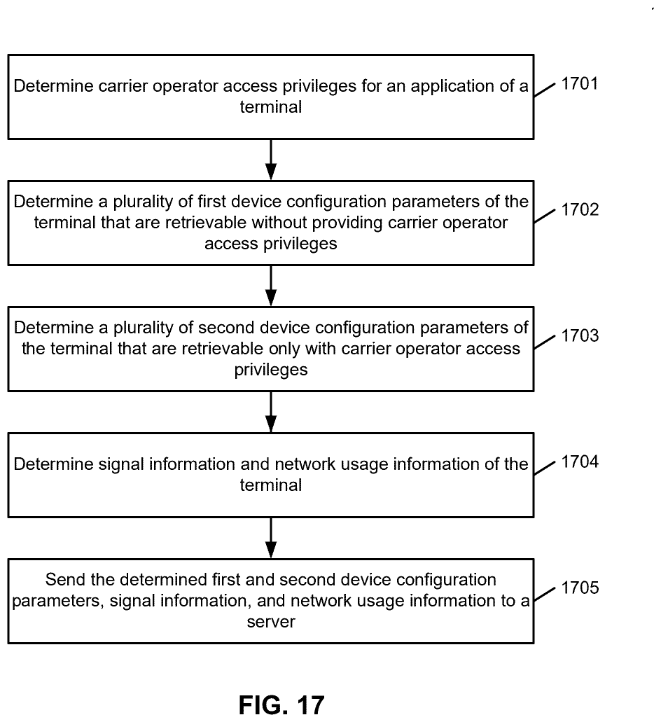

FIG. 17 is a flow diagram illustrating an example of a method to monitor terminal information according to one embodiment. Process 1700 may be performed by processing logic which may include software, hardware, or a combination thereof. For example, process 1700 may be performed by monitor module 213 and/or data transmission module 214 of FIG. 2.

Referring to FIG. 17, at block 1701, processing logic determines carrier operator access privileges for an application (e.g., frontend application) of the terminal.

At block 1702, processing logic determines first device configuration parameters of the terminal that are retrievable without providing carrier operator access privileges.

At block 1703, processing logic determines second device configuration parameters of the terminal that are retrievable without providing carrier operator access privileges.

At block 1704, processing logic determines signal information and network usage information of the terminal.

At block 1705, processing logic sends the first and second device configuration parameters, signal information, and network usage information to a server.

In one embodiment, processing logic further receives diagnostics information for the terminal, where the server performs diagnostics for the terminal based on the first and second device configuration parameters, signal information, and network usage information, and one or more historical snapshots for the terminal to generate diagnostics information for the terminal, where the historical snapshots comprise first and second device configuration parameters, signal information, and network usage information for the terminal. In one embodiment, terminal receives the diagnostics information via a push notification.

In one embodiment, the diagnostics information is obtained from an inference using a machine learning model based on the first and second device configuration parameters, signal information, network usage information, and the one or more historical snapshots.

In one embodiment, the machine learning model is trained to identify one or more configurations that are at fault for degrading a performance.

In one embodiment, the network usage information comprises: data service data, SMS service data, and voice service data.

In one embodiment, the second device configuration parameters that are retrievable only with carrier operator access privileges comprise: International Mobile Equipment Identity (IMEI), voice over LTE (VOLTE), access point name (APN) Internet, APN IP Multimedia Subsystem (IMS), Preferred Network Type, Configuration parameters of the Preferred Network Type, and Network selection mode.

In one embodiment, the first device configuration parameters that are retrievable without providing carrier operator access privileges comprises: brand, model, OS version, manufacturer of the terminal, WiFi configuration, battery saving mode, tethering hotspot configuration, data roaming configuration, and device location.

In one embodiment, processing logic further receives a reconfiguration request to reconfigure one least one of the second device configuration parameters at the terminal to fix any identified malfunctions at the terminal.

In one embodiment, processing logic further receives a scheduling request from the server, where the first and second device configuration parameters, signal information, and network usage information are determined in response to receiving the scheduling request.

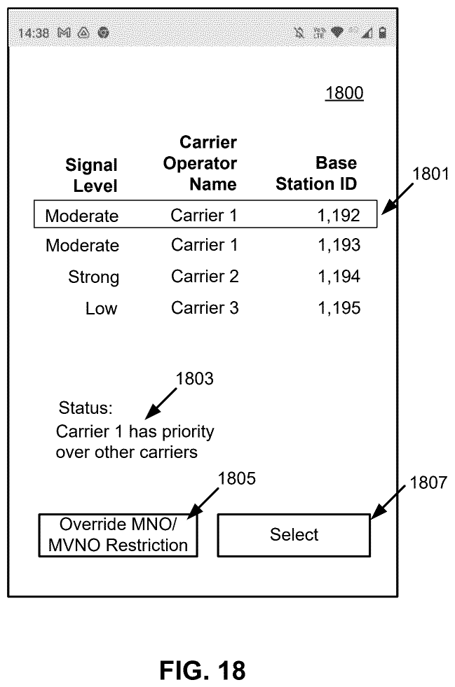

FIG. 18 illustrates a UI 1800 for user to select a base station (e.g., access network device) to service a terminal according to one embodiment. Referring to FIG. 18, UI 1800 can be provided by a frontend app, such as frontend app 151A-151B of FIG. 1. UI 1800 can list one or more base stations that can be seen by the carrier frequencies and bandwidth of a terminal device. For example, a terminal device detects the base stations within proximity to the terminal device and that covers the carrier frequency and transmission protocols (e.g., 2G, 3G, 4G, etc.) of the terminal device and lists these base stations in an order based on their proximity. Information about the base stations, such as the transmit/receive signal levels, name of the carrier operators, and base station identifiers can be determined by the terminal and be associated to these base stations. UI 1800 can display a selection 1801 for one or more existing base stations that are currently servicing the terminal. In one embodiment, end user can select the base station from the list of base stations to provide network services to the terminal device via button 1807. For example, a user can select, by a touch screen of the terminal device, a base station, such as base station with identifier 1,194, to service the terminal device. In one embodiment, the selected base station needs to meet a minimum signal level threshold (e.g., moderate signal level) for the selection to be in effect. In one embodiment, the selection can be reverted when the switching is detected to cause a connectivity issue or performance degradation for the terminal device. In one embodiment, the terminal further sends diagnostics information (including the first and/or second device configuration parameters as described above) of a current access network device to a server prior to switching the terminal to the target access network device. For example, if the diagnostics information indicates the signal information fails to meet a predetermined threshold or indicates that there is outstanding diagnostic issues with the terminal, then the switching to the target access network device takes effect. That is, the switching takes effect when the terminal in communication with the current access network device experiences performance issues. In some embodiments, the manual switching by the end user takes precedence over change requests from a Mobile Virtual Network Operator (MVNO) or a Mobile Network Operator (MNO) of the terminal device. In some embodiments, change requests from a Mobile Virtual Network Operator (MVNO) or a Mobile Network Operator (MNO) of the terminal device takes precedence over the manual switching by the end user.

An operator typically provides a set of access network device switching policies at the SIM of a terminal. In some embodiments, the MVNO or MNO of the terminal can signal a different restriction (or steering of roaming) to the terminal to select services from a subset of carrier operators, and the restriction can be displayed at a status box 1803. Steering of roaming is a strategy that allows home operators to direct traffic to the roaming partners with which they have the best agreements. In some instances, these restrictions are more favorable to the business objections of the MVNO or MNO (e.g., carrier operators or virtual operators). The following scenario illustrates this concept. A terminal is under contract with operator 1 and is in an area with services from operators 1-2. A base station of operator 2 might experience an increase in signal power. In this case, even when operator 1 provides proficient wireless services, the terminal may switch to operator 2 due to better signaling. Operator 2 then charges back operator 1 for servicing the terminal since the terminal is not part of its network. Thus, placing a restriction in the carrier prioritization to not to switch to operator 2, e.g., remain with carrier 1, can refrain the terminal from switching to operator 2.

In this case, even when carrier 2 indicates a strong signal level, terminal would not automatically switch to carrier 2 and, by default, a user would not be able to manually select carrier 2. In some embodiments, these restrictions can be applied by an operator based on a geographic location of the terminal. In another embodiment, the user can override (e.g., nullify) a restriction that the MNO/MVNO has placed on the terminal via button 1805. That is, the user can now freely switch over to carrier 2.

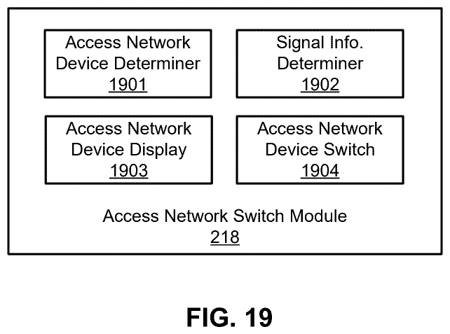

FIG. 19 is a block diagram illustrating an access network switch module 218 according to one embodiment. Access network switch module 218 can switch the access network for a terminal device. In one embodiment, access network switch module 218 includes access network device determiner 1901, signal information determiner 1902, access network device display 1903, and access network device switch 1904. Access network device determiner 1901 can determine the access network devices (e.g., base stations) that provides wireless signal strengths above a predetermined threshold, e.g., within proximity to the terminal device. Signal information determiner 1902 can determine the signal information of these access network devices. In some embodiments, the signal information can further include an identifier for a carrier operator, transmit signal strength, receive signal strength, signal bandwidth, signal jitter, a signal protocol (e.g., 2G, 3G, LTE, 5G, etc.) and the like. Access network device display 1903 can display a list of the available access network devices. An example of a display is shown in FIG. 18. Access network device switch 1904 can perform a switch of the access network device for the terminal. In some embodiments, the signal information of the target access network device is required to satisfy a predetermined condition. For example, the signal information of the target access network device must meet predefined thresholds, e.g., signal strength is greater than a threshold, signal bandwidth greater than a bandwidth threshold, signal jitter less than a jitter threshold, etc. Some or all of submodules 1901-1904 can be integrated into a single submodule.

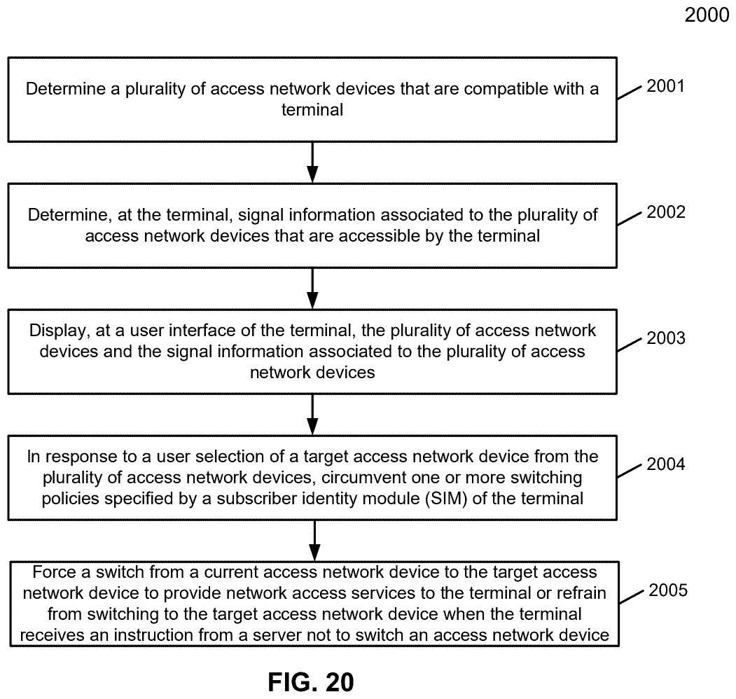

FIG. 20 is a flow diagram illustrating an example of a method to switch an access network device of a terminal according to one embodiment. Process 2000 may be performed by processing logic which may include software, hardware, or a combination thereof. For example, process 2000 may be performed by an access network switch module of a terminal device, such as access network switch module 218 of FIG. 19.

Referring to FIG. 20, at block 2001, processing logic determines a plurality of access network devices that are accessible by the terminal.

At block 2002, processing logic receives signal information associated to the plurality of access network devices.

At block 2003, processing logic displays, at a user interface of the terminal, the plurality of access network devices and the signal information associated to the plurality of access network devices.

At block 2004, in response to a user selection of a target access network device from the plurality of access network devices, processing logic circumvents one or more switching policies specified by a subscriber identity module (SIM) of the terminal. The policies are configurable by an MVNO/MNO for the terminal device.

At block 2005, processing logic forces a switch from a current access network device to the target access network device to provide network access services to the terminal or refrains from switching to the target access network device when the terminal receives an instruction from a server not to switch an access network device.

In one embodiment, the signal information includes a transmit signal strength, a receive signal strength, a signal protocol, and/or a carrier operator of the access network device.

In one embodiment, processing logic further sends diagnostics information of the terminal to a server prior to switching the terminal to the target access network device, where the diagnostics information includes at least a cellular signal not meeting a threshold or inability of the terminal to transmit cellular data to a carrier operator.

In one embodiment, processing logic further reverts the target access network device to a previous access network device to provide network access services to the terminal when the switching is detected to cause a connectivity issue or performance degradation for the terminal device.

In one embodiment, processing logic further sends a number of second device configuration parameters to a server, where the second device configuration parameters are retrievable only with carrier operator access privileges and comprise: International Mobile Equipment Identity (IMEI), voice over LTE (VOLTE), access point name (APN) Internet, APN IP Multimedia Subsystem (IMS), Preferred Network Type, Configuration parameters of the Preferred Network Type, and Network selection mode.

In one embodiment, processing logic further sends a number of first device configuration parameters to a server, wherein the first device configuration parameters are retrievable without providing carrier operator access privileges and comprise: brand, model, OS version, manufacturer of the terminal, WiFi configuration, battery saving mode, tethering hotspot configuration, data roaming configuration, and device location.

In one embodiment, processing logic further receives an indication from a server that indicates whether malfunctions have been identified at the terminal based on a diagnostics of the terminal using the first and second device configuration parameters of the terminal. In response to receiving an access network device change request from a Mobile Virtual Network Operator (MVNO) or a Mobile Network Operator (MNO), processing logic overrides the request when there is a user selection for a target access network device. Processing logic performs the access network device change request when there is an absence of a user selection for a target access network device or when there is an indication of identified malfunctions at the terminal.

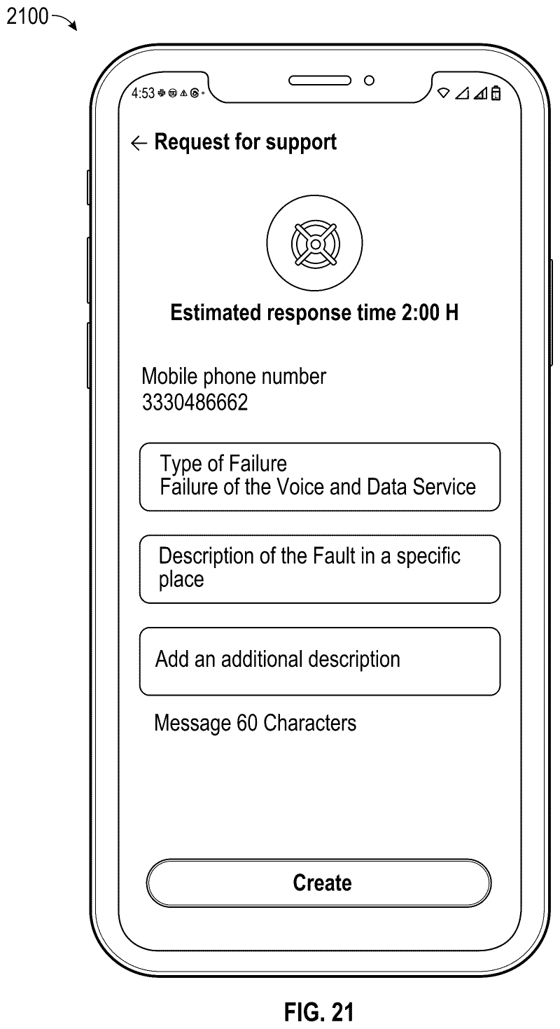

FIG. 21 illustrates a UI 2100 for a user to create a support ticket according to one embodiment. UI 2100 can be a display panel generated when a user clicks on the “request for support” panel in UI 300 of FIG. 3. UI 2100 provides a user with the fields to select a type of failure, a description of the failure, and add additional description. In one embodiment, the frontend app belongs to a third party and when the user creates the support ticket, the support ticket is sent to a corresponding MNO or MVNO of the terminal device for the user. In one embodiment, server 103 proposes (e.g., automatically creates the ticket for the user to finalize and submit the ticket) a support ticket to the user from customer experience information and/or diagnostics information of the terminal. In some embodiments, server 103 can proactively propose (auto-generate) the ticket with or without intervention from a customer support agent. For example, server 103 can employ a machine learning model to consume the customer experience information and/or diagnostics information of the terminal to propose the support ticket. In some embodiments, the auto-generation of the support ticket can be customized based on different types of incidents/events of the terminal device. For example, the user can specify what types/category of incidents to auto-generate the support ticket. A few types of incidents can include connectivity outages (voice outages, data outages, SMS outages), connectivity performance issues, technical incidents with hardware failures, technical incidents with software failures, security incidents (malicious app/websites, phishing, cyberattack, etc.), non-compliance incidents, etc.

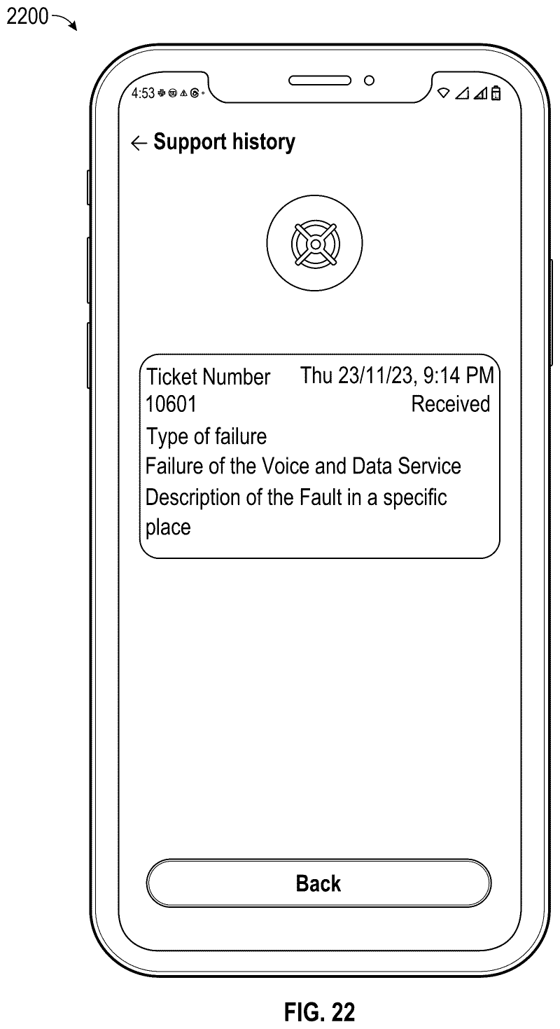

FIG. 22 illustrates a UI 2200 with historical support tickets according to one embodiment. Here, a list of support tickets is shown for the terminal device. In one embodiment, the list of support tickets can include a ticket that is manually created by a user. In one embodiment, the list of support tickets can include a ticket that is automatically created by frontend app on behalf of the user. In one embodiment, the list of support tickets can include a ticket that is created by the MVNO or MNO of the user.

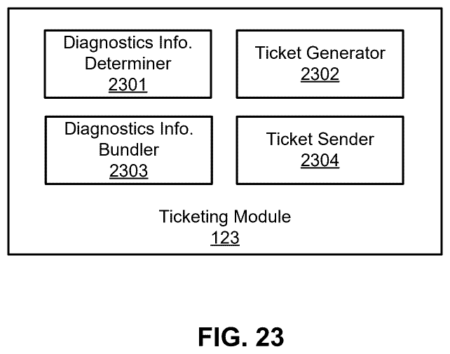

FIG. 23 is a block diagram illustrating a ticketing module 123 for a terminal according to one embodiment. Ticketing module 123 can provide a support ticket system for a terminal device. Support tickets can be forwarded to a MVNO and/or MNO of the terminal. In one embodiment, ticketing module 123 includes diagnostics information determiner 2301, ticket generator 2302, diagnostics information bundler 2303, and ticket sender 2304. Diagnostics information determiner 2301 can determine the diagnostics information for the terminal at a particular time instance. Ticket generator 2302 can generate a support ticket for the terminal. The support ticket can be used by a support agent (e.g., an agent of MVNO or MNO) to diagnose the terminal for malfunctions/performance issues. Diagnostics information bundler 2303 can bundle diagnostics information to the support ticket. For example, the support ticket and the diagnostics information can be grouped into a single file and/or converted to a binary format. The file can then be streamed from the terminal to a server for customer support. Ticket sender 2304 can send the support ticket to a third-party. In one embodiment, ticket sender 2304 determines the MVNO/MNO and sends the support ticket to the MVNO/MNO. Some or all of submodules 2301-2304 can be integrated into a single submodule.

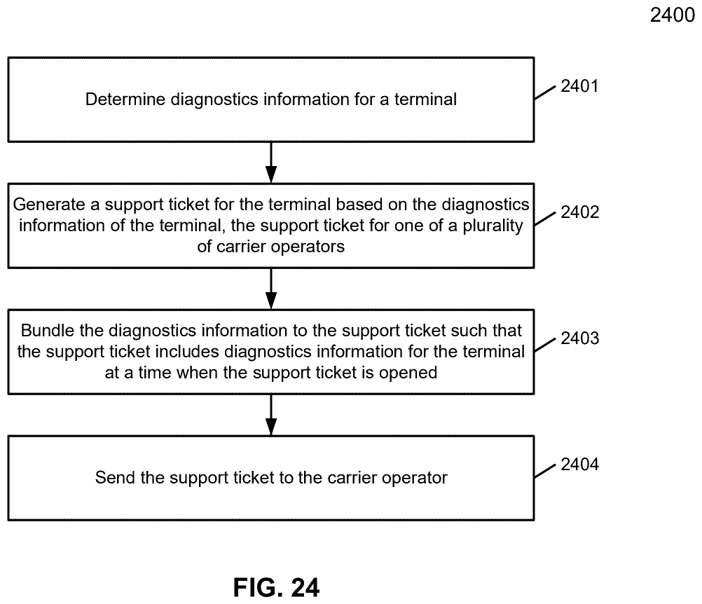

FIG. 24 is a flow diagram illustrating an example of a method to generate a support ticket for a terminal according to one embodiment. Process 2400 may be performed by processing logic which may include software, hardware, or a combination thereof. For example, process 2400 may be performed by a ticketing module of a terminal device, such as ticketing module 123 of FIG. 23.

Referring to FIG. 24, at block 2401, processing logic determines diagnostics information for a terminal. The diagnostics information can indicate some signal information fail to meet predetermined thresholds or can indicate that there is outstanding diagnostic issues with the terminal. In one embodiment, the diagnostics information includes first and second device configuration parameters, signal information, and/or network usage information as described above. These information can be used to assist a support agent in diagnosing the terminal. In some embodiments, the diagnostics information can include one or more historical snapshots for the terminal, where the historical snapshots include previous time periods of first and second device configuration parameters, signal information, and/or network usage information for the terminal. In one embodiment, the diagnostics information can be obtained from an inference using a machine learning model. Here, the inference can indicate a diagnostic issue and the configuration parameters that likely cause the diagnostic issue.

At block 2402, processing logic generates a support ticket for the terminal based on the diagnostics information of the terminal, the support ticket for one of a plurality of carrier operators (e.g., MVNO or MNO).

At block 2403, processing logic bundles the diagnostics information to the support ticket such that the support ticket includes diagnostics information for the terminal at a time when the support ticket is opened. For example, the support ticket and diagnostics information can be converted to a single binary file.

At block 2404, processing logic sends the support ticket to the carrier operator (e.g., MVNO and/or MNO). In one embodiment, a single binary file is streamed to the MVNO/MNO.

In one embodiment, the diagnostics information includes a plurality of first device configuration parameters of the terminal that are retrievable without providing carrier operator access privileges, a plurality of second device configuration parameters of the terminal that are retrievable only with carrier operator access privileges, and signal information and network usage information of the terminal.

In one embodiment, the network usage information comprises: data service data, SMS service data, and voice service data.

In one embodiment, the second device configuration parameters that are retrievable only with carrier operator access privileges comprise: International Mobile Equipment Identity (IMEI), voice over LTE (VOLTE), access point name (APN) Internet, APN IP Multimedia Subsystem (IMS), Preferred Network Type, Configuration parameters of the Preferred Network Type, and Network selection mode.

In one embodiment, the first device configuration parameters that are retrievable without providing carrier operator access privileges comprise: brand, model, OS version, manufacturer of the terminal, WiFi configuration, battery saving mode, tethering hotspot configuration, data roaming configuration, and device location.

In one embodiment, generating a support ticket for the terminal includes generating in an application of the terminal, the support ticket for the terminal, or generating, by a server, the support ticket for the terminal.

In one embodiment, the ticket is used by the carrier operator to track and diagnose a mobile connectivity issue at the terminal and the ticket is closed when then mobile connectivity issue at the terminal is resolved.

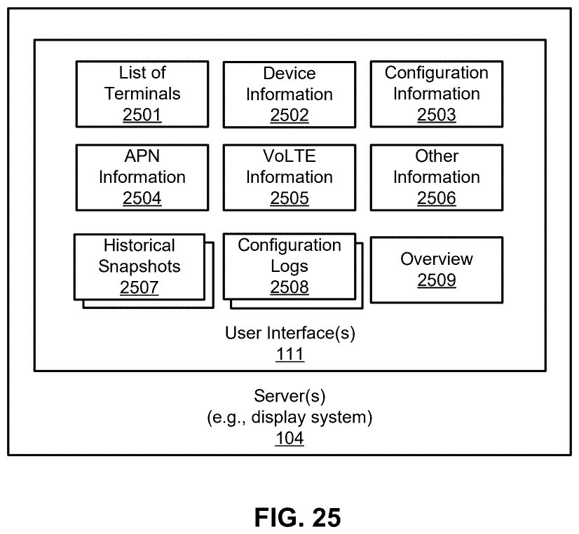

FIG. 25 is a block diagram illustrating a user interface 111 for a server 103/104 according to one embodiment. UI 111 can provide a visual display system for a support agent to analyze and diagnose terminals. The support agent can be an agent of a third-party software provider or an agent of a MVNO and/or MNO of the terminal. In one embodiment, UI 111 includes display/user interfaces (e.g., UIs) that display list of terminals 2501, device information 2502, configuration information 2503, APN information 2504, VOLTE information 2505, other information 2506, historical snapshots 2507, configuration logs 2508, and overview 2509. Each of 2501-2509 can be displayed in one or more user interfaces of the server(s) 104-105.

List of terminals 2501 can show the terminals that enroll in the services of a frontend app. Referring to UI 2600 of FIG. 26, list of terminal devices 2501 can show terminals and a summary of respective information (e.g., name, model, android ID, device number, SDK version, diagnostics compliance, timestamp of the diagnostics, and OS version) for the terminals. Diagnostics compliance can indicate a number of signal measurements for a terminal that meet respective predefined thresholds. The terminals can be of any types (android OS, Harmony OS, etc.) and from any manufacturers, such as Google Pixel, Samsung Galaxy, POCO S4, Huawei GT5, etc. UI 2600 can further display a number of mobile users enrolled on a particular day 2601, the number of users enrolled that week 2603, and an average number of users enrolled over the last 30 days 2605. In one embodiment, UI 2600 can display a customer sentiment indicator. For example, the sentiment indicator can be the compliance column. In some embodiment, the sentiment indicator can correspond to a rating (0 to 5 stars) feedback that a user provides in the app and the rating is indicated next to the list of terminals on UI 2600.

Device information 2502 can show the device information related to a particular terminal. Referring to FIG. 27, UI 2700 can display device information 2502, configuration information 2503, APN information 2504, VOLTE information 2505, and other information 2506. In an embodiment, UI 2700 shows when the terminal device has last checked-in, a number of configurations being compliant, a number of other configurations that are compliant, any outstanding support tickets for the terminal device. Here, compliance refers to a ratio of configurations that meet their predefined thresholds to a total number of configurations. UI 2700 can further display homologation and policy information 2701, which indicates whether the terminal device (e.g., configuration parameters and features) are compatible to the frontend app (e.g., SDK homologation), and/or the carrier operator (e.g., carrier homologation). Information 2701 can display the SDK version for frontend app.

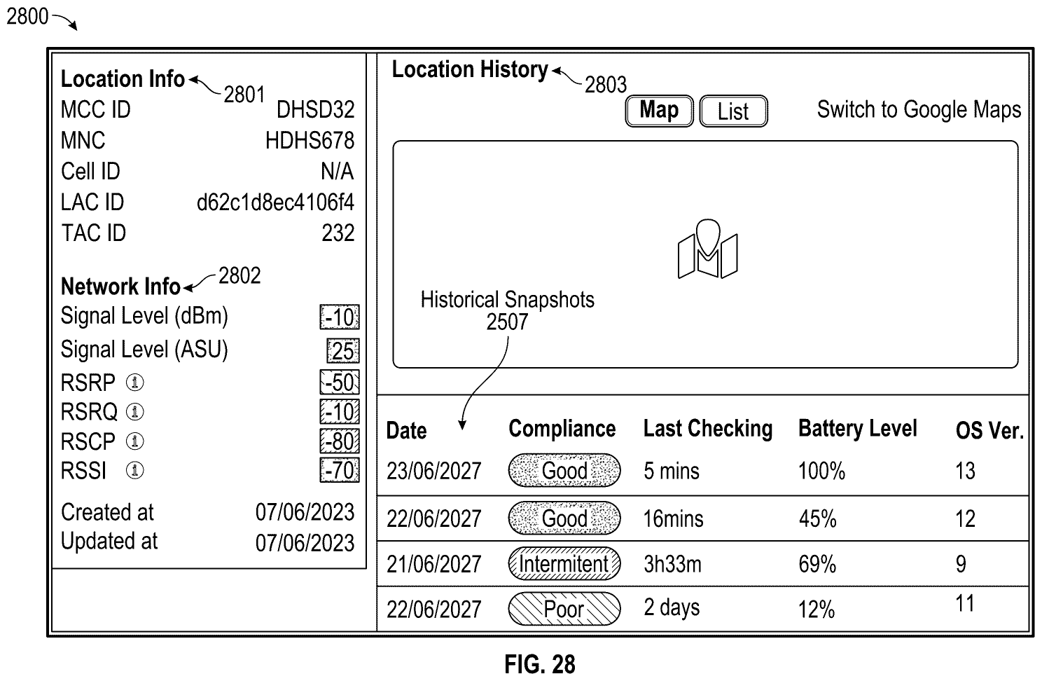

Historical snapshots 2507 can show a history of customer experience information for a particular terminal. Referring to FIG. 28, UI 2800 can include the location information 2801 for the terminal, network information 2802 reported by the terminal, historical locations 2803 displayed in a map, and historical snapshots 2507 of the terminal. Historical snapshots 2507 can include a summary of customer experience information of the configuration parameters of the terminal, when the last time the terminal checked in, battery level of the terminal, and OS version of the terminal.

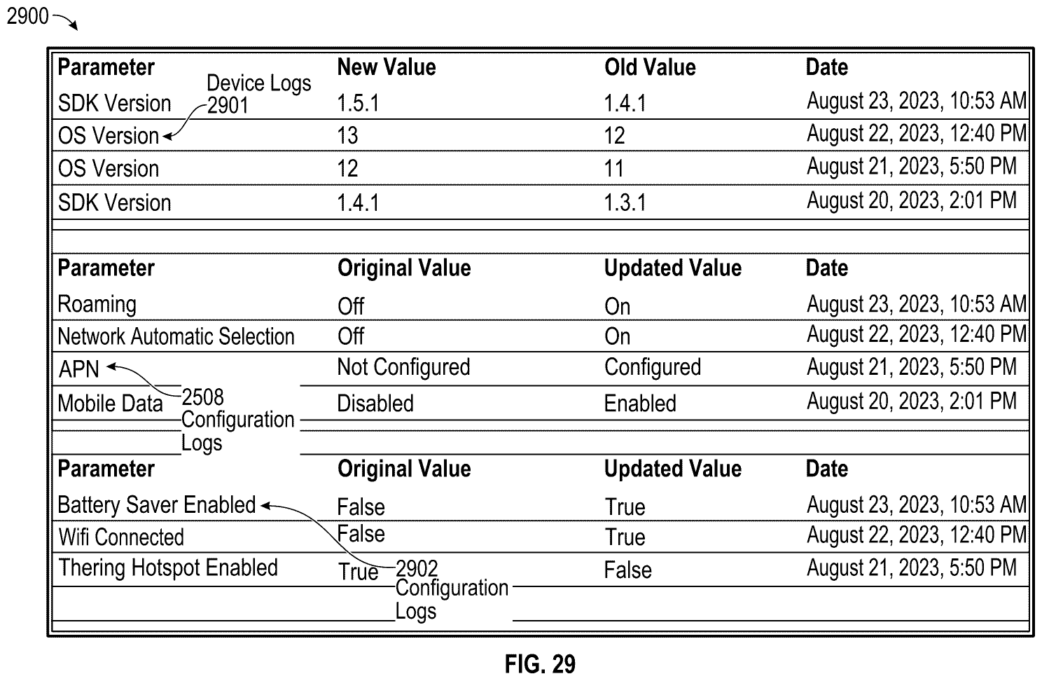

Configuration logs 2508 can show change/error logs for the configuration parameters of a terminal. Referring to FIG. 29, UI 2900 can include device logs 2901, configuration logs 2508, and other configuration logs 2902. Each of these logs can show labels for the parameters, the original parameter values, the updated parameter values, and a date/time when the change has occurred. Device logs can show change/error logs for the device settings of the terminal device. Other configuration logs can show change/error logs for the miscellaneous configurations of the terminal device.

Overview 2508 can display a UI for an overview (such as FIGS. 26 and 30) of all the terminals subscribed to the services of server 103.

FIG. 30 illustrates a UI 3000 for a configurations overview of enrolled terminals according to one embodiment. UI 3000 can show the configuration statuses of all enrolled terminals in a single display UI. In one embodiment, UI 3000 can include display panels: app homologation 3001 (e.g., SDK homologation), MNO homologation 3002, compliance breakdown 3003, and device compliance 3004. App homologation 3001 can indicate a count of the terminal devices that are compliance versus non-compliance, where the compliance requirements are specified by an SDK for the frontend app. Examples of compliance requirements can include customizations and/or versions of the operator systems for a particular manufacturer. In this case if the terminal reports the customizations and/or versions of the OS for the terminal is within a predetermined list, the terminal is considered compliant. MNO homologation 3002 can indicate a count of the terminal devices that are compliance versus non-compliance where the compliance is specified by a MNO. For example, server 103 can receive a list of terminals that are compliant for the MNO. Server can then display the list of terminals in UI 3000. Compliance breakdown 3003 can show a breakdown of the compliance number by each of the main configurations and/or other configurations. Device compliance 3004 can indicate a count of the terminal devices that are compliance versus non-compliance, where the compliance is specified by a server, such as server 103 of FIG. 1. Viewing the UIs of FIG. 26-30, an operator can gauge the mobile experience satisfaction (e.g., customer sentiment via in-app user prompts in combination from data of user terminal's coverage, data capacity, quality of service (QOS), recent filed support tickets, etc.) for various mobile subscribers with RF drive tests.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A method, comprising:
receiving, by a server, a plurality of first device configuration parameters of a terminal that are retrievable without providing carrier operator access privileges;
receiving, by the server, a plurality of second device configuration parameters of the terminal that are retrievable only with carrier operator access privileges;
receiving, by the server, signal information and network usage information of the terminal;
determining one or more historical snapshots of first and second device configuration parameters, signal information, and network usage information for the terminal; and
performing diagnostics for the terminal based on the first and second device configuration parameters, signal information, network usage information, and the one or more historical snapshots to identify malfunctions at the terminal.

2. The method of claim 1, wherein performing diagnostics for the terminal comprises:
comparing the historical snapshots of the first and second device configuration parameters, signal information, and network usage information against the received first and second device configuration parameters, signal information, and network usage information to identify respective differences; and
providing an alert when any of the identified differences satisfies a respective predetermined condition.

3. The method of claim 1, wherein performing diagnostics for the terminal comprises:
performing an inference using a machine learning model based on the first and second device configuration parameters, signal information, network usage information, and the one or more historical snapshots; and
providing an alert based on a result of the inference.

4. The method of claim 3, wherein the machine learning model is trained to identify one or more configurations that are at fault for degrading a performance of the terminal.

5. The method of claim 1, wherein the network usage information comprises: data service data, SMS service data, and voice service data.

6. The method of claim 1, wherein the second device configuration parameters that are retrievable only with carrier operator access privileges comprise: International Mobile Equipment Identity (IMEI), voice over LTE (VOLTE), access point name (APN) Internet, APN IP Multimedia Subsystem (IMS), Preferred Network Type, Configuration parameters of the Preferred Network Type, and Network selection mode.

7. The method of claim 1, wherein the first device configuration parameters that are retrievable without providing carrier operator access privileges comprise: brand, model, OS version, manufacturer of the terminal, WiFi configuration, battery saving mode, tethering hotspot configuration, data roaming configuration, and device location.

8. The method of claim 1, further comprising:
reconfiguring one least one of the second device configuration parameters at the terminal to diagnose identified malfunctions at the terminal.

9. The method of claim 1, further comprising:
transmitting the received first and second device configuration parameters, signal information, and network usage information of the terminal to a carrier operator for the carrier operator to identify terminal malfunctions.

10. The method of claim 1, further comprising: scheduling the first and second device configuration parameters, signal information, and network usage information to be received at a predetermined period from the terminal.

11. A method, comprising:
determining, by a terminal, carrier operator access privileges for an application of the terminal;
determining, by the terminal, a plurality of first device configuration parameters of the terminal that are retrievable without providing carrier operator access privileges;
determining, by the terminal, a plurality of second device configuration parameters of the terminal that are retrievable only with carrier operator access privileges;
determining, by the terminal, signal information and network usage information of the terminal; and
sending the first and second device configuration parameters, signal information, and network usage information to a server.

12. The method of claim 11, further comprising: sending, by the terminal, diagnostics information for the terminal to the server, wherein the server performs diagnostics for the terminal based on the first and second device configuration parameters, signal information, and network usage information, and one or more historical snapshots for the terminal, wherein the historical snapshots comprise first and second device configuration parameters, signal information, and network usage information for the terminal.

13. The method of claim 11, wherein the diagnostics information is obtained from an inference using a machine learning model based on the first and second device configuration parameters, signal information, network usage information, and the one or more historical snapshots.

14. The method of claim 13, wherein the machine learning model is trained to identify one or more configurations that are at fault for degrading a performance.

15. The method of claim 11, wherein the network usage information comprises: data service data, SMS service data, and voice service data.

16. The method of claim 11, wherein the second device configuration parameters that are retrievable only with carrier operator access privileges comprise: International Mobile Equipment Identity (IMEI), voice over LTE (VOLTE), access point name (APN) Internet, APN IP Multimedia Subsystem (IMS), Preferred Network Type, Configuration parameters of the Preferred Network Type, and Network selection mode.

17. The method of claim 11, wherein the first device configuration parameters that are retrievable without providing carrier operator access privileges comprises: brand, model, OS version, manufacturer of the terminal, WiFi configuration, battery saving mode, tethering hotspot configuration, data roaming configuration, and device location.

18. The method of claim 11, further comprising:
receiving a reconfiguration request to reconfigure one least one of the second device configuration parameters at the terminal to fix any identified malfunctions at the terminal.

19. The method of claim 11, further comprising: receiving a scheduling request from the server, wherein the first and second device configuration parameters, signal information, and network usage information are determined in response to receiving the scheduling request.

20. A non-transitory machine-readable medium having instructions stored therein, which when executed by a processor, cause the processor to perform operations, the operations comprising:
receiving, from a terminal, a plurality of first device configuration parameters of the terminal that are retrievable without providing carrier operator access privileges;
receiving, from the terminal, a plurality of second device configuration parameters of the terminal that are retrievable only with carrier operator access privileges;
receiving, from at the terminal, signal information and network usage information of the terminal;
determining one or more historical snapshots of first and second device configuration parameters, signal information, and network usage information for the terminal; and
performing diagnostics for the terminal based on the first and second device configuration parameters, signal information, network usage information, and the one or more historical snapshots to identify malfunctions at the terminal.
